(19) United States
(12) Patent Application Publication
(10) Pub. No.: US 2002/0156663 A1
(43) Pub. Date: Oct. 24, 2002

(54) Shipping and transportation optimization system and method

(75) Inventors: David Weber, Olney, MD (US); Peter B. Suskind, McLean, VA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc.

(21) Appl. No.: 09/903,855

(22) Filed: Jul. 13, 2001

Related U.S. Application Data
(60) Provisional application No. 60/218,640, filed on Jul. 13, 2000.

(51) Int. Cl. G06F 17/60

(52) U.S. Cl. 705/7

(57) ABSTRACT

The present invention provides a supply management system and method, which is useful to determine optimal supply chain configurations. Within the method of the present invention, the user sets up a supply chain model, specifies conditions for optimization, optimizes the supply chain model, and analyzes the optimal supply chain and fine-tunes the supply chain model. The user sets up the supply chain model by providing various information. The user may further define various purchase, source, and make processes that occur in the supply chain. The user may also specify resources used in the supply chain. In defining these resources, the user may further designate multi-tiered pricing. The user may also specify constraints for the process and resources. Tax and information related to international locations may also be specified. After establishing the supply chain model, the user may further define optimization conditions for finding optimal solutions. The user may further define scenarios in which the user modifies the supply chain model and then accesses the impact of this change. The supply chain is then optimized using linear programming if the supply chain does not include multi-tiered pricing or maximum sourcing. If the supply chain includes multi-tiered pricing or maximum sourcing, the network is optimized using mixed integer programming and heuristics.

### RELATED APPLICATIONS

This application claims priority from U.S. Provisional Application Ser. No. 60/218,640, filed Jul. 13, 2000, the disclosure of which is hereby incorporated by reference in its entirety.

### FIELD OF THE INVENTION

The present invention relates to a supply chain management system and method for determining an optimal, cost-minimizing set of supply chain decisions based upon expected profits and costs for processes within the supply chain.

### BACKGROUND OF THE INVENTION

Today's business environment has opened opportunities for new business expansions as well as optimization of existing business. At the same time, businesses are simultaneously experiencing ever-decreasing price and profit erosion. A well-managed supply chain that designs and optimizes global trading networks over time by product, customer, product life cycle, and location for maximum profits and minimized costs is critical. Toward this goal, businesses spend a great deal of administrative resources to determine optimal business network design and policy decisions that minimize supply chain costs and maximize profits.

However, because of the complex and ever-changing nature of the modern economy, it is often difficult for a business to model and to optimally manage its supply chains. The inability to create a network design and policy that balances limited resources, global suppliers, multi-echelon networks, and international trade requirements causes numerous inefficiencies. These inefficiencies include poor asset utilization, unnecessary customs fees and delays, and decreased cash flow.

To assist a company in managing a supply chain, the company may automatically obtain information on the sourcing of supplies and materials. For example, U.S. Pat. Nos. 6,023,683 and 6,055,516, issued to Johnson et al., for Electronic Sourcing System, provide a computer that maintains a catalog database of data, including product information (such as product identification and descriptive information) relating to catalog items available from vendor product catalogs, and a means for building (generating) a requisition including at least one requisitioned item. Information at least partially identifying an item desired to be requisitioned is entered by a user, and utilized by a means for searching the database for catalog items matching that information and for selecting at least one catalog item located as a result of the search. Text describing the catalog items, and images of the items, may be viewed. Data identifying selected catalog items are communicated to the requisition building means, which generates a requisition, including entries for items corresponding to the selected catalog items. The system checks the availability in one or more inventory locations of the corresponding desired catalog items, and generates one or more purchase orders for desired items from inventory locations stocking the items.

To further assist in the management of a supply chain, a business may use known software to automatically manage the delivery of products to customers/resellers. For instance, U.S. Pat. No. 6,167,380, issued to Kennedy et al., for System And Method For Allocating Manufactured Products To Sellers, provides a software system for managing the fulfillment of customer requests. The software system includes a plurality of generic product models, each representing a different generic product. Each generic product model specifies one component of a plurality of possible components. A plurality of specific product models each represents a specific product, and each specifies all components of the specific product. Each component specified by each specific product model is specified by one of the generic product models such that each specific product model is related to a subset of the generic product models. A customer request matching a specific product then can be fulfilled by available inventory of the specific product or by available inventory of related generic products. In addition, an organization in a seller hierarchy can retain product and designate first-come-first-served product. The organization also can define a time frame horizon to specify when forecasted product is actually available. Further, the organization can use an automatic allocation policy to allocate to members, and some forecast entries can be designated as having no available inventory.

To further assist businesses in managing a supply chain, it is further known in the current state of the art to electronically model certain elements or limited aspects of a supply chain. For example, U.S. Pat. No. 6,157,915, issued to Bhaskaran et al., for Method and Apparatus For Collaboratively Managing Supply Chains, provides an active collaboration technology in an open architectural framework that delivers information and decision support tools to present a collaborative dynamic decision-making capability to a community of role players within a supply chain process. The comprehensive collaborative dynamic decision-making capability is made possible through the integration of the business process, the organization of role players, and relevant business applications. In this way, the operations of several businesses that operate within a supply chain may be integrated.

Similarly, U.S. Pat. No. 5,974,395, issued to Bellini et al. for System And Method For Extended Enterprise Planning Across A Supply Chain, provides a system for extended enterprise planning across a supply chain. The system includes transactional execution system layers for a demand enterprise and a supply enterprise. First and second federated electronic planning interchange layers provide a data specification format and an external communication interface for transactional execution system layers. A supply chain planning engine, operable to perform planning for the supply chain, is in communication with a third federated electronic planning interchange layer that provides a data specification format and an external communication interface for the supply chain planning engine. A data access/transfer layer interconnects and allows transfer of information among the first, second, and third electronic federated planning interchange layers. The supply chain planning engine, the first transactional execution system, and the second transactional execution system can thereby communicate data that the supply chain planning engine can use to provide constraint-based extended enterprise planning across the supply chain.

It is also known, as described in U.S. Pat. No. 6,009,406, issued to Nick for Methodology And Computer-Based Tools For Re-Engineering A Custom-Engineered Product Line, to provide a methodology for designing a supply chain to better meet the needs of customers, such as ensuring the on-time delivery of a certain percentage of orders. In this method, an in-depth review of a product line is conducted, including customer interviews, to identify customer specifications that are more complex than customer needs. Customer needs are quantified, and a reduced set of standard product configuration classes are selected so that a percentage of customer orders based on actual customer needs can be satisfied by the standard product configuration classes, and the remaining orders can be satisfied by custom design. Major components in the standard products are themselves standardized. Manufacture of the standard product is optimized for a one-day manufacturing cycle and separated from the manufacture of the custom designed product. A sales office and manufacturing plant rollout schedule is implemented and managed by computer-based spreadsheet tools. A product configuration computer program module is interfaced between a product selector and a materials management (MRP) system in order to automate the process of entering orders, designing the standard product, ordering parts, and scheduling assembly of the standard product.

It is also known in the art to model a supply chain for specific situations. For example, U.S. Pat. No. 6,243,493 issued to Cherneff et al. for Computer-Implemented Product Development Planning Method, provides a computer-implemented system for planning a supply chain for a new product in development. More specifically, the system models a business enterprise in terms of its proposed products and the tasks and resources used to develop them. In this system, an optimizing engine comprised of a genetic algorithm and a constraint engine operates on the model to construct candidate product portfolios and schedules. Each schedule is evaluated and used to generate an improved candidate portfolio in accordance with genetic processing. This process continues to improve the product prioritization and pipeline schedule, as measured in terms of an objective criterion such as profit maximization.

Nevertheless, there remains a need for a more ideal supply chain management system and methodology. In particular, a more ideal supply management solution provides an accurate, time-phased view to support optimal design and policy decision making. The more ideal supply management solution should model trading network implications to determine a profitable business strategy. Specifically, the ideal supply chain optimization tool should evaluate a given supply chain and determine an optimal configuration for this supply chain. The known supply chain management tools instead address issues of optimal creation of the supply chain and cannot assist in the day-to-day operations of an existing supply chain. In determining the optimal business strategy for the supply chain, or network, the more ideal supply chain management tool should examine numerous factors, including optimal inventory levels, appropriate product mix across the network, optimal production, storage, and distribution locations, optimal sourcing plans and lane volumes, and appropriate seasonal pre-builds and customer service levels.

In forming the business strategy, the more ideal supply chain management tool, in view of these numerous and complex business factors, should employ sophisticated optimization techniques. In particular, the more ideal supply chain management tool, unlike the above-described or other known, network optimization tools, should address the multiple dimensions of time, location, product, customer, cost, and profit. The more ideal supply chain management tool should employ sophisticated optimization techniques that simultaneously balance profits, time-phased demand and supply, fixed and variable costs, varying transportation and manufacturing lead-times, and global constraints such as tariffs and value-added taxes.

In addition, the more ideal supply chain management tool should provide a global view of the trading network that not only allows for flexible units-of-measure and multi-currency capabilities, but also recognizes that policy and design recommendations must consider international trade regulations and local content compliance. Accordingly, the more ideal supply chain management tool should determine more profitable, time-phased supply chain strategies by optimizing global network design and network policies as well as integrating global customers, suppliers, contract partners, and sites. In performing these functions, the more ideal supply chain management tool should consider international trade logistics in order to decrease global trading costs.

Overall, the more ideal supply chain management tool should include detailed modeling capabilities to ensure accurate network representation and solutions. The more ideal supply chain management tool should further compute changes in costs and profits from geographic changes in the supply chain or from the substitution of goods and resources within the supply chain. The more ideal supply chain management tool should also improve asset utilization by comparing multiple alternatives. Likewise, the more ideal supply chain management tool should simulate product mix and seasonal pre-builds to provide adequate levels of customer service.

### SUMMARY OF THE INVENTION

In response to these and other needs, the present invention provides a supply management system and method in which it is useful to determine optimal supply chain configurations. Within the method of the present invention, the user sets up a supply chain model, specifies conditions for optimization, optimizes the supply chain model, analyzes the optimal supply chain, and fine-tunes the supply chain model.

The user establishes the supply chain model by providing various information. For example, the user may specify information on the locations in the supply chain, such as plants, distribution centers (DCs), suppliers, and customers. Likewise, the user may specify lanes defining the transportation network connecting locations. The user may further identify items in the supply chain, such as raw materials, works-in-process (WIPs) or unfinished goods, and finished goods, as well as defining stock keeping units (SKUs) used to identify the items at the different locations. The user may further define various purchase, source, and make processes that occur at the location and lanes in the supply chain. The user may also specify resources used in the processes of supply chain, such as labor, machinery, production, inventory, in-handling, out-handling, transportation, and extra transportation. In defining these resources, the user may further designate multi-tiered pricing or specify a maximum number of sources for each location. The user may also define hard and soft constraints for the processes and resources. Tax and information related to international locations may also be specified.

After establishing the supply chain model, the user may further define scenarios in which the user modifies the supply chain model and then assesses the impact of this change. The user then defines optimization conditions for finding optimal solutions to the supply chain model. Typically, these goals are the minimization of costs or the maximization of profits.

The supply chain is then optimized using linear programming if the supply chain does not include multi-tiered pricing or a maximum number of sources for a location. If the supply chain includes multi-tiered pricing, the network is optimized using mixed integer programming and heuristics. More specifically, the heuristics employs successive linear programming to find possible optimal solution and local searching to assess the validity of the possible optimal solution. Similar techniques may be employed if the user has specified a maximum number of sources providing a resource to a location.

In another embodiment, the present invention further includes a system for implementing this supply chain optimization method.

### BRIEF DESCRIPTION OF THE DRAWINGS

These and other advantages of the present invention are described more fully in the following drawings and accompanying text in which like reference numbers represent corresponding parts throughout:

FIG. 1 is a flowchart that illustrates a supply chain management method in accordance with an embodiment of the present inventions;

FIGS. 2A-2H, 3, and 4A-C are flowcharts that illustrate steps in the supply chain management method of FIG. 1, in accordance with various embodiments of the present invention;

FIG. 2I is an exemplary supply chain model produced through the steps illustrated in FIGS. 2A-2H, in accordance with an embodiment of the present invention;

FIGS. 5-9 are graphs that illustrate different pricing curves formed through the multi-tiered pricing, in accordance with embodiments of the present invention;

FIGS. 10-11 are schematic illustrations of a supply chain management system in accordance with embodiments of the present invention; and

FIGS. 12A-12 are illustrations of possible output displays from the supply chain management systems of FIGS. 10-11.

### DETAILED DESCRIPTION OF THE PREFERRED EMBODIMENT

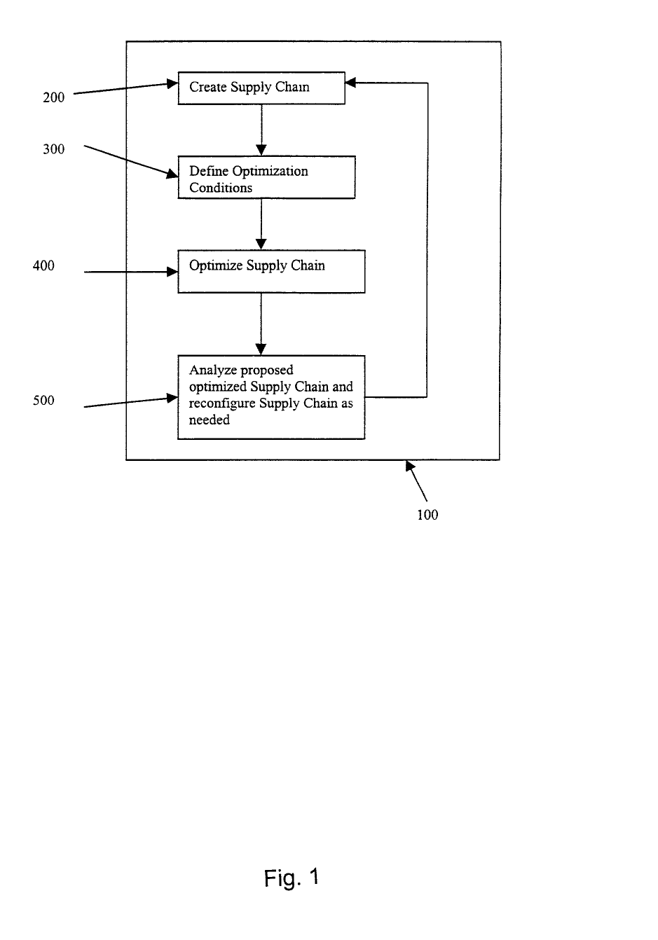

As generally illustrated in FIGS. 1 and 10-11, the present invention provides a supply chain management method 100 and a related supply chain management system 1000 to help a user manage an overall supply chain at a strategic and tactical level. The present invention can answer both strategic and tactical planning questions. On a strategic level, the present invention can help the user simulate alternatives for new facilities or plan for capital expenditures. On a tactical level, the present invention can help the user determine, among other things, an optimal network of suppliers, plants, and distribution centers; determine a best strategy for managing plant capacity, critical materials, and labor based on either minimum cost or maximum profit; determine the best strategy for inventory movement through the network; and determine what changes are needed in order to meet customer delivery time requirements.

In addressing these questions, the present invention assists the user in making some critical decisions about the future by predicting long-term effects (i.e., 12-18 months into the future) of changes in the supply chain. For instance, the present invention allows the user to predict the effects of opening a new manufacturing plant because of a foreseen increase in demand of the user's product. Similarly, the present invention assists the user to predict the results of removing elements of the supply chain, such as shutting down a distribution center that is doing poorly and not handling as much volume as in the past. Such changes in the supply chain are extremely complex because they influence the other elements of the supply chain and may necessitate other changes to the supply chain. For example, closing one location may require the rerouting of distribution and transportation.

The present invention also helps the user look at shorter-term (such as 3 to 12 months away) effects of changes to the supply chain, thereby allowing the user to make better decisions about more current, tactical activity within the user supply chain. For example, if the user opened a new manufacturing plant, the present invention could help the user in deciding how much to manufacture in the near future, how much to ship between the new plant and a distribution center, how much stock to have at the plant, the lowest cost or most profitable customer service policy, etc.

As described in greater detail below, the supply chain management method 100 illustrated in FIG. 1 addresses the important role of network optimization and design. The supply chain management method 100 helps the user to find the right mix of long-term supplier relationships, plant and distribution center locations, transportation lanes, delivery times to customers, and inventory strategies that will result in the most cost-effective or profitable structure for the supply chain. Accordingly, the supply chain management method 100 helps the user more effectively plan the supply chain, such as buying raw materials, manufacturing the product, and distributing the finished good to the user's customers. The supply chain management method 100 generally helps the user in designing and implementing a supply chain that minimizes costs or maximizes profits.

Returning to FIG. 1, the user implements the supply chain management method 100 by performing the steps of setting up a supply chain model, step 200; setting up the conditions for optimization, step 300; optimizing this supply chain model, step 400, and analyzing the optimal supply chain and fine-tuning the supply chain model, step 500.

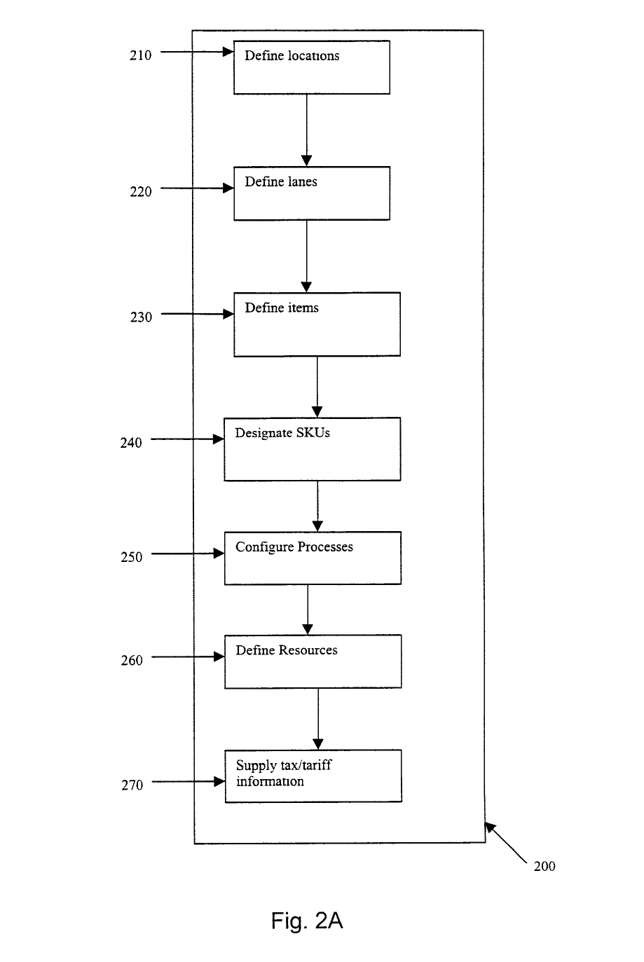

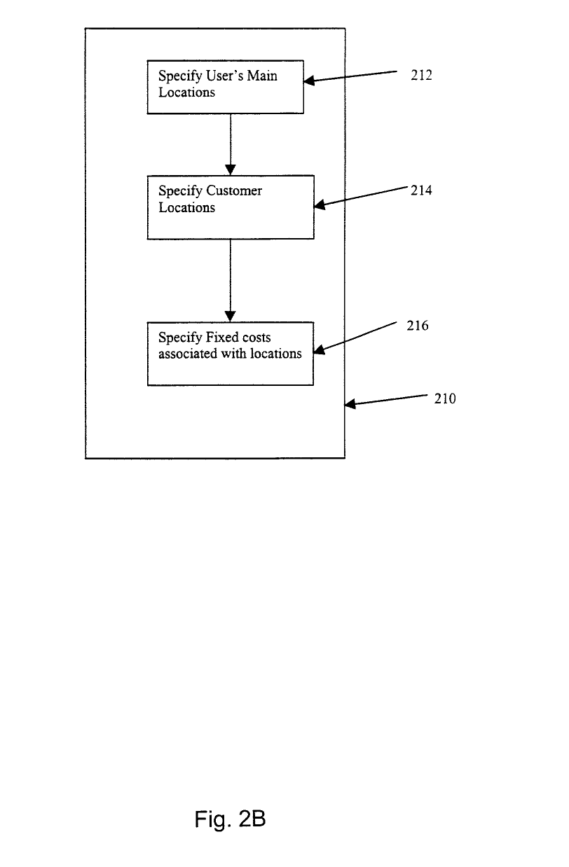

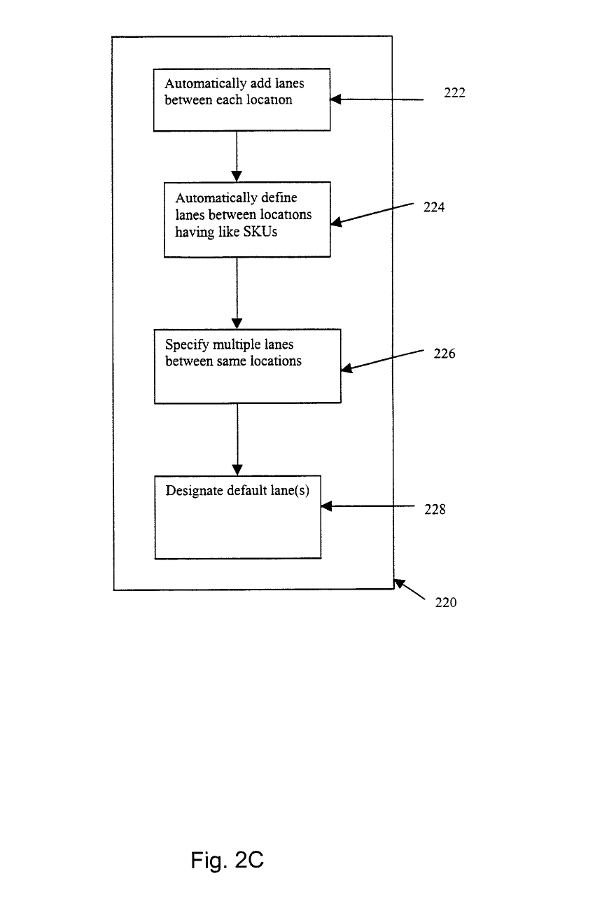

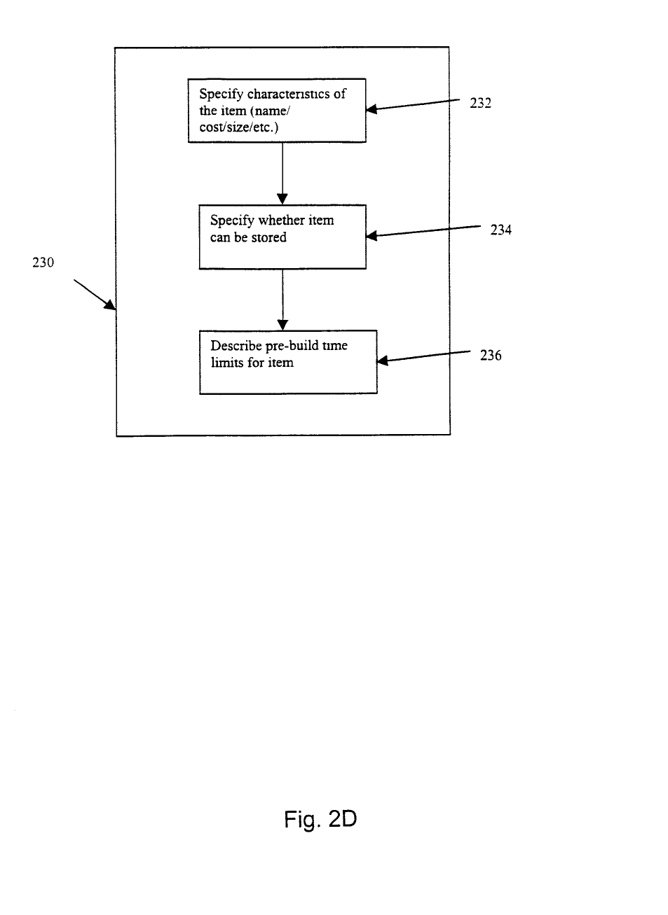

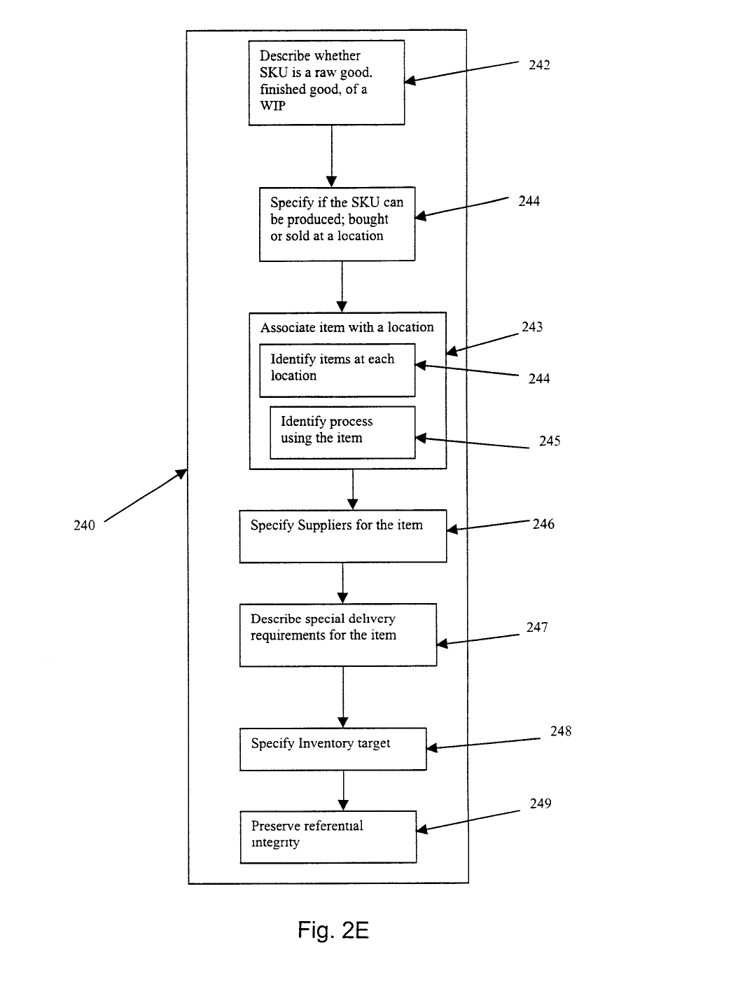

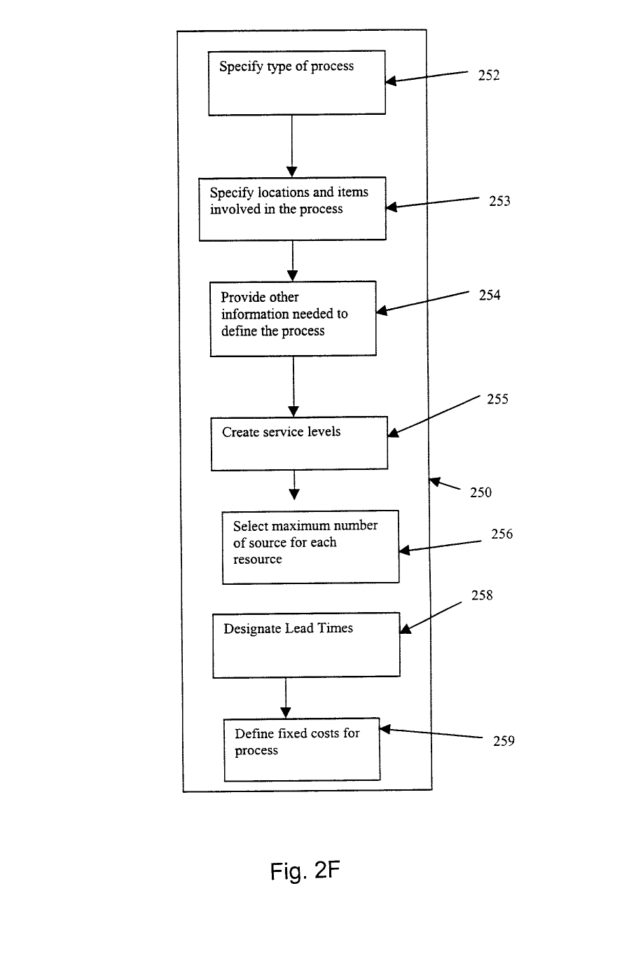

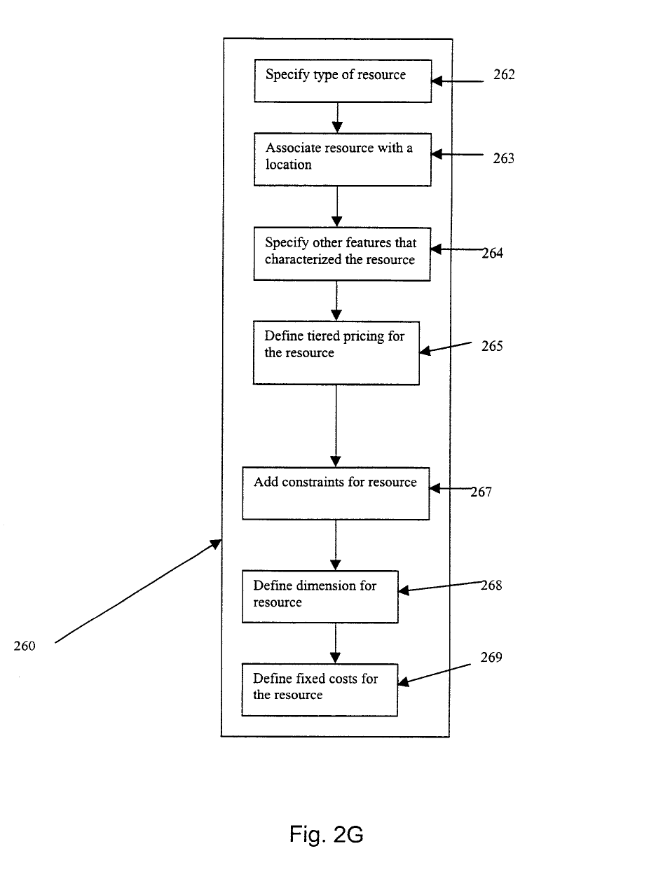

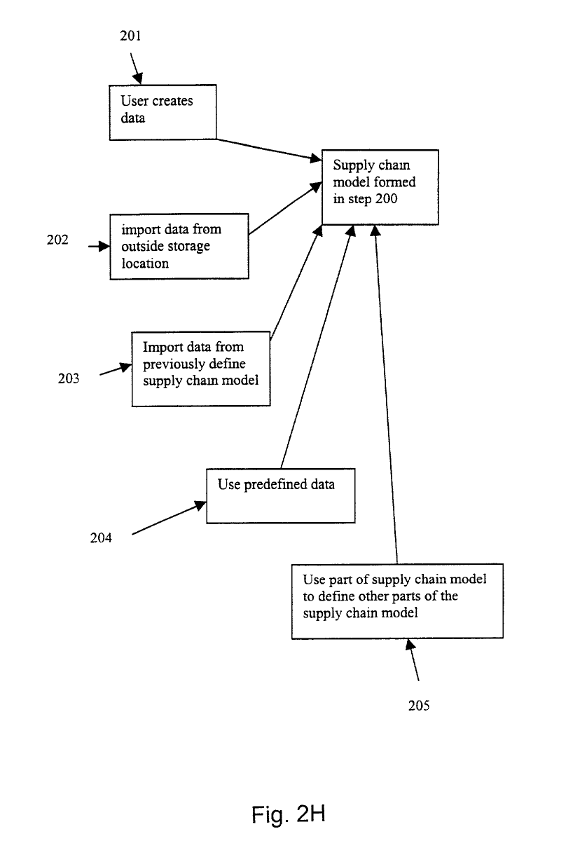

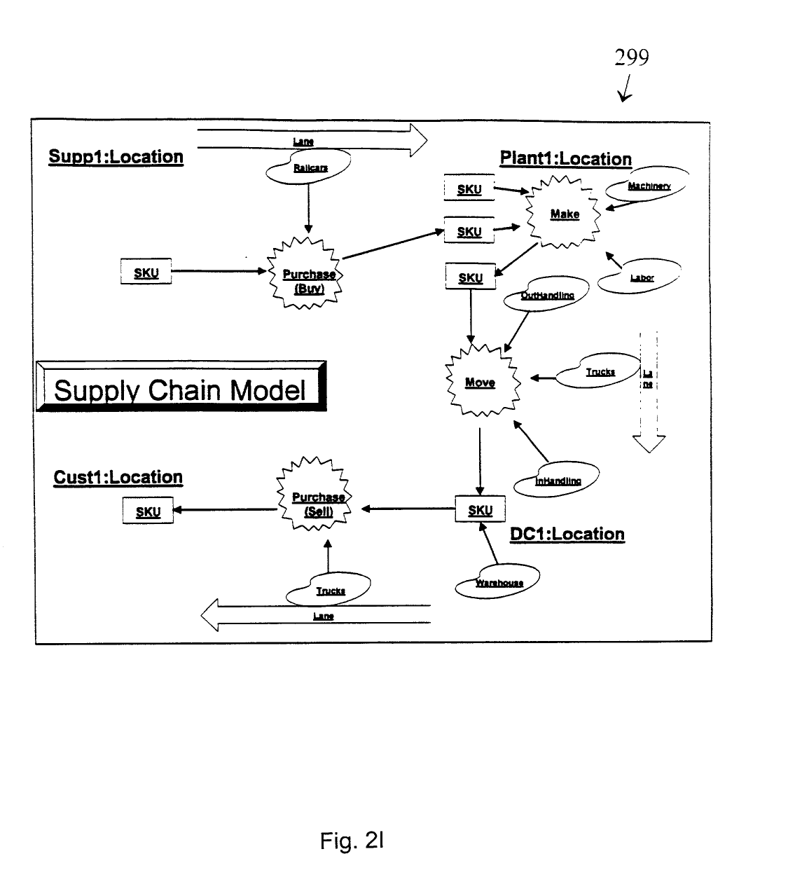

The supply chain defined in step 200 is modeled using various information provided by the user. More specifically, as illustrated in FIG. 2A, the user supplies numerous types of information during the step of setting up a model of the user's supply chain, the step 200. For example, the user may specify the geographic locations of elements in the supply chain, such as plants, distribution centers (DCs), suppliers, and customers, step 210. Likewise, the user may specify lanes defining the transportation network connecting locations, step 220. In step 230, the user may further identify items in the supply chain, such as raw materials, works-in-process (WIPs) or unfinished goods, and finished goods, as well as defining stock keeping units (SKUs) used to identify the items at the different locations, step 240. The user may further define various purchase, source, and make processes that occur in the supply chain, step 250. These processes are described in greater detail below. The user may further specify resources used in the supply chain, such as labor, machinery, production, inventory, in-handling, out-handling, transportation, and extra transportation, step 260. It should be appreciated that the above list of information used to define the supply chain is non-exhaustive and meant merely as an illustrative sampling of possible data. Accordingly, numerous other facts and information may be included in defining the supply chain within the present invention. The data provided by the user in step 200 may be stored in an electronic database or other information storage medium. The individual steps of defining the supply chain model in step 200 are now described in greater detail below.

Setting up a supply chain model therefore involves re-creating the structure and activities of the user's supply chain network—the user's suppliers, plants, distribution centers, and customer locations and the lanes connecting them (as well as the associated processes and SKUs), step 210. A supply chain model may be as simple as two locations with lanes between them, transporting items from one place to another, with costs associated with the resources used for transportation. Alternatively, the supply chain model may be highly complex, such as one having dozens of locations with lanes connecting the location and thousands of SKUs at each of the locations, with each of the locations, lanes, and SKUs having associated penalties, constraints, and costs. A sample supply chain model 299, as defined through step 200, is schematically illustrated in FIG. 2I.

As described above, the process 200 for creating a supply chain model begins with defining locations within the supply chain network or the structure of the supply chain, step 210. In step 210, the user should ideally provide as much information as possible on the location, as necessary to define the supply chain. Typically, the user defines the locations as illustrated in FIG. 2B. Specifically, the user first identifies main locations in the supply chain, such as main manufacturing plants, suppliers, and DCs that the user uses to produce and move the user's products, step 212. The suppliers provide the raw materials necessary to manufacture the user's products, the plants manufacture the user's products, and the DCs store and distribute the user's WIPs and finished goods. The user may further specify that a location defined in step 212 serves more than one function. For example, a plant may also serve as a DC. Optionally, the user may further specify customer locations, step 214. Customers buy the user's products, whether those products are the main result of the user's primary business operation or a by-product of that operation. In defining a customer location, the user may specify the physical site for the location. The activities that occur at the location and the units at the location are defined in latter steps, as described below. As part of defining the locations, the user may further specify any fixed costs associated with the locations, step 216. For example, the user may identify rent costs, equipment depreciation, management costs, taxes, insurance, etc.

After the locations are identified in step 210, the user specifies lanes connecting these locations in step 220. Lanes are needed to move items between locations. Typically, the user will also add transportation resources (described below) to move items across the lanes between the locations. Referring to FIG. 2C, in one embodiment, of the present invention, lanes are automatically defined between each of the locations, step 222. In a preferred implementation, lanes are automatically defined between locations having like items or SKUs, step 224. The user may specify multiple lanes between the same locations, step 226. This feature allows the user to model more than one transportation option per lane (e.g., rail versus freight). However, the user specifies only one lane as the default lane, step 228. A default lane's resources are automatically used by any process that is not associated with a specific lane between the same two locations connected by the default lane.

The user then designates the items that are sold, bought, or produced in the supply chain, step 230. Specifically, the items defined in step 230 are the user's raw materials, WIPs, or finished goods. For example, if the user is making chicken and rice soup, the user raw material items might include 10-ounce cans, labels, and each of the soup ingredients; the WIPs might include labeled cans and mixed soup; and the finished good would be a case of 10-ounce cans of chicken and rice soup.

Referring to FIG. 2D, the user specifies the characteristics of each item in step 232 defining each of the items, the user will typically further specify whether the item can be stored, step 244. For example, the item may be perishable raw materials or storable WIPs. The user further specifies any pre-build time limitation for each of the item, step 246. The pre-build time limitation limits how far in advance the item can be manufactured.

Once the items and locations have been defined, SKUs may be created, step 240. A SKU is a stock keeping unit and specifically identifies an item at a location. The same item may be produced at a first location, stored as an intermediary product at a second location, and used to produce other items at a third location. For example, the user may have flour at a supplier or at a plant; cookies at a plant, cookies at a distribution center, or cookies at the customer. SKUs play an important role in supply chain model setup. They are the raw materials that are input to a process, the WIPs that are in various stages of completion at a plant, the finished goods that are manufactured at a plant, or the product that needs to be delivered to customers within a specific time frame. Referring to FIG. 2E, the user specifies whether the SKU is a raw material, WIP, or a finished product, step 241. The user similarly specifies whether the SKU is manufactured, bought, or sold at one of the user locations, step 242. Furthermore, the user may specify whether a customer SKU has delivery time requirements, as described below in the discussion of customer service level. In a preferred implementation, the user also preserves referential integrity, step 249, so that the like items have like reference designations at different locations in different processes. The user also associates the items with locations, step 243. Specifically, for each of the locations specified in step 210, the user designates the items residing at the location, step 244, and the processes to be associated with the items at the location, step 245. For example, at supplier locations, the user further specifies suppliers for the items or the pre-builds needed to form the item, step 246. Likewise, for customer sites, the user specifies delivery requirements for the items, step 247.

Returning to FIG. 2E, in another configuration, the user may specify an inventory target for the supply chain model, step 240. While inventory resources were described above in step 260 as being an input that helps to define and model the process, inventory may be also defined as a result of the processes in the supply chain. Specifically, today's inventory is developed from prior purchase and make processes. Likewise, the desired level of inventory for the future is shaped by expected future demand. Therefore, the user may specify a target inventory level to achieve after one or more planning periods, given operation of the supply chain during the planning period(s). The target inventory should fall between any minimum or maximum inventory levels otherwise specified by the user in defining the supply chain. During optimization of the supply chain, the inventory for a SKU after a planning period is found by summing the original inventory for the SKU with any net changes purchase or make processes during the planning period. In this way, the effect of the supply chain on inventory levels may be determined. As part of step 240, the user also defines a penalty for not meeting target inventory levels, step 248. The user may further specify whether the target inventory is a hard or soft constraint.

At this point, the user may identify the business processes that occur at each of the locations, step 250. The business processes define the operations at each of the locations, such as the buying, making, moving, or selling of an item. As illustrated in FIG. 2F, the user defines a business process by first specifying the type of process, step 252. The user may designate the process as one of three basic types of business operations. More specifically, the user may define a purchase process that generally relates to either purchasing from suppliers or selling to customers of raw materials, partially finished goods or finished goods from suppliers. Alternatively, the user may define a make process related to manufacturing finished goods from raw materials. The user may also define a move process related to the physical transfer of raw materials, WIP, or finished goods throughout the network. Another type of process, a source process, relates strictly to the transfer of goods between plant DC locations. The user may combine and use various combinations of these processes as needed to specifically model the day-to-day operations of a business to describe aspects of the supply chain, such as describing how the SKUs move through the user's network.

Returning to FIG. 2F, the user further defines the processes by specifying the locations and items involved in process, step 253. The user may then provide other information as needed to describe the process in the supply chain model, step 254.

The purchase processes calculate the overall cost of using a designated raw material supplier or of selling products to customers. The process of defining the purchase process begins with the user determining the items and the locations to purchase from suppliers or the items to sell to customers. The user then specifies the price for purchasing the items from the suppliers or for selling the item to the customers.

The make process calculates the overall cost of manufacturing finished goods or converting raw materials into intermediate materials or finished goods. To create a make process, the user determines the items and the location involved in the make process. Specifically, the user should specify the items used in the make process and the items produced in the make process. The user should further designate the costs for the make process. As part of determining the costs for the make process, the user should identify the resources used in the make process, such as labor.

The process of creating a move or sourcing process in step 250 involves defining the items and lanes involved in the move and defining the costs to move the item in the lane. Given this information, the move process calculates the cost of moving raw materials, intermediate materials, or finished goods through the supply chain network. To model the process effectively, the user should configure appropriate transportation lanes, transportation resources, and costs and capacities for those resources. In defining the move or sourcing process, the user should also consider the kinds of transportation might move on each of the lanes. The user should further specify a way to measure the capacity of the transportation resource, as well as a way to measure the amount of an item involved in the move process. In determining the costs for the move process in the step, the user should further consider whether to include in-handling and out-handling resources to account for costs associated with receiving and shipping.

A process defined in step 252 generally relates either to a single location defined in step 210 or to a lane defined in step 220. For example, if a business moves finished goods from a plant to a DC, the user should add a move process on the lane between the two locations.

For many businesses, the delivery of the right product, to the right place, at the right time is becoming an increasingly important priority in supply chain operations. Returning to FIG. 2F, the user may, while defining a SKU or location, specify one or more service levels for the SKU or location, step 255. Service levels or sets of service levels are used to define how quickly products are delivered to customers. Specifically, the user sets a percentage of the product that must be shipped within a certain period of time. This percentage can be a percentage of either the product revenue, where certain revenue is delivered to a customer within a certain time period, or product volume, where a certain amount of a product is delivered to a customer within a certain time period. Optimization of the supply chain model then provides feasible solutions that minimize cost or maximize profit while meeting the selected service level specification. In essence, the service level functions as hard constraints, as described in greater detail below in step 267.

There are a number of situations when service levels can benefit the user's supply chain. In most situations, the user specifies a service level for individual customer SKUs or for individual customer locations, which include all SKUs at that location. For example, the user may manufacture a product that has a preferred customer, to whom the user wants to insure shipment. The user may have other customers requesting this same product, but these other customers are not as demanding in their delivery requirements. By setting a service level, the user seeks a solution that meets the demand of the preferred customer first, even if it is more costly to do so, while still satisfying the less demanding customer. Alternatively, one customer may be willing to pay more for a certain amount of a product to be shipped quickly. Setting a service level allows the user to seek supply chain solutions in which this customer has a desired percentage of the product shipped within a short time frame, while a remaining percentage is shipped within a longer time frame.

The formulation of service levels in step 255 is now described. In defining a service level requirement, for each calendar period t, the user first defines a service percentage, P (0≦P≦1) and a lead-time requirement, D ≧0. For example, setting P=0.95 (representing 95%) and D=2 days would require that 95% of the total revenue (volume) be delivered within 2 days.

For a service level by SKU volume, Aₜ is the total revenue (volume) that arrives in period t by sell processes with the SKU x as output, which have lead-time ≦D. Then Bₜ is the total revenue (volume) that arrives in period t by sell processes with x as output, with lead-time >D. Then the constraint will be:

Aₜ/(Aₜ+Bₜ)≧P, or (1−P) Aₜ−P Bₜ≧0. Equation 1

For a sell process s that supplies x, let Zₜ(s) equal 1 if the service level is by volume or let Zₜ(s) equal the selling price of x via s if the service level is by revenue. A sell process can override the selling price of its output SKU, so Zₜ(s) may be x's the selling price or it may be the overridden price. Service levels by revenue are incompatible with multi-tiered prices, so if s has a multi-tiered price (as described below in step 265), Zₜ(s) is the local price for s.

By the above definitions for Aₜ and Bₜ,

Aₜ=ΣRₜ₋ₚ(s)Zₜ(s)Xₜ₋ₚ(s); and sεN(x,D) Equation 2

Bₜ=ΣRₜ₋ₚ(s)Zhd t(s)Xₜ₋ₚ(s) sεF(x,D) Equation 3

where

N(x,D) is the set of all sell processes s with x as the output SKU and lead-time L(s)≦D;

F(x,D) is the set of all sell processes s with x as the output SKU and lead-time L(s)>D;

Rₜ(s) is the requirement quantity of x for s in calendar period t;

Zₜ(s) is the selling price of x via s;

Xₜ(s) is the number of executions of process s in calendar period t;

p=p(s,t) is the number of periods from period t encompassed by lead-time L(s).

Thus, the result of an execution of sell process s started in period t will arrive at x's location at the beginning of period t+p.

Combining Equations 2 and 3 with Equation 1, the constraint becomes:

(1−P)ΣRₜ₋ₚ(s)Zₜ(s)Xₜ₋ₚ(s)−PΣRₜ₋ₚ(s)Z ₜ(s)Xₜ₋ₚ(s)≧0sεN(x,D)SεF(x,D) Equation 4

Viewed as coefficients of the executions of sell processes s that supply x, Equation 4 may be rewritten as:

ΣΣKₜ(s)X_{τ}(s)≧0, sτ+p(s,τ)=t Equation 5

where

$$\begin{matrix}{K}_{τ} ( s ) = ( 1 - P ) {Z}_{t} ( s ) {R}_{τ} ( s ) & if L ( s ) \leq D \\ = - P {Z}_{t} ( s ) {R}_{τ} ( s ) & if L ( s ) > D\end{matrix} ,$$

0≦τ≦t=τp(s,τ)≦T−1, and

T is the number of planning calendar periods.

Setting a service level by location is similar, except that Aₜ is redefined as the total revenue (volume) that moves by sell processes with any SKU at customer location C as output and lead-times less than D. Likewise, Bₜ is the total revenue (volume) that moves by sell processes with any SKU at location C as output and lead-time more than D. Therefore, Aₜ and Bₜ may be mathematically rewritten as:

Aₜ=Σ(ΣRₜ₋ₚ(s)(s)Zₜ(s)Xₜ₋ₚ(s)(s)) x@C sεN(x,D) Equation 6

Bₜ=Σ(ΣRₜ₋ₚ(s)(s)Zₜ(s)Xₜ₋ₚ(s)(s)) x@C sεF(x,D) Equation 7

where

Σ((1−P)ΣRₜ₋ₚ₍ₛ₎(s)Zₜ(s)X_{t-p(c)}(s)−PΣRₜ₋ₚ₍ₛ₎(S)Z₊(s)Xₜ₋ₚ₍ₛ₎(S))≧0 sεN(x,D)sεF(x,D) Equation 8

For service level by volume, all of the coefficients for Rₜ(s) must have been converted to a common unit of measure. If service level is by revenue, the unit of measure of Rₜ(s) must be the same as the denominator unit of measure of Zₜ(s), and the numerator unit of measures of all selling prices Zₜ(s) must be the same for all t and s.

Viewed as coefficients of the executions of sell processes s that supply SKUs at C, Equation 8 may be written as:

ΣΣK_{τ}(s)X_{τ}(s)≧0, sτ+p(s,τ)=t Equation 9

where

$$\begin{matrix}{K}_{τ} ( s ) = ( 1 - P ) {Z}_{t} ( s ) {R}_{τ} ( s ) & if L ( s ) \leq D ; \\ = - P {Z}_{t} ( s ) {R}_{τ} ( s ) & if L ( s ) > D ; and\end{matrix}$$

0≦τ≦t=τ+p(s,τ)≦T−1

given T is the number of calendar periods.

Returning to FIG. 2F, the user may further specify a maximum number of sources for a SKU in the solution, step 256. In following this “max sourcing” step, a SKU can only be sourced from no more than the specified number of locations. In all cases, max sourcing is viewed from the perspective of the location receiving the SKUS. Max sourcing can only be applied to SKUs that exist at plants, DCs, plant-DC combinations, and customers. As with any constraint (see below is step 268), max sourcing places restrictions on the model and never produces a less costly or more profitable solution than the one that was generated without max sourcing.

Max sourcing may be defined by location or by SKU. Location max sourcing requires all SKUs received at a destination location to originate from no more than the specified number location(s). For example, if a location called the New York Plant has 50 SKUs and the user only want it to be sourced by two locations, all SKUs to the New York plant must originate from the same one or two locations.

In contrast, SKU max sourcing requires each selected SKU to originate from less than the specified number of sources but not necessarily the same sources as the other SKUs. Selected SKUs are sourced from the number of specified origins but they do not have to share the same origins. For example, if the user specifies one source for Item A and Item B, Item A it New York location may be sourced from Chicago, but Item B at the New York location may be sourced from Atlanta. It should be appreciated that the user need not select all the SKUs at a location, For instance, the user may want to max source high-value or critical components but let other components come from any available source. The user may further group SKUs so that some could be sourced from a first common same location and others from another location.

The user may further mix Location and SKU max sourcing in one model. For example, a New Orleans DC can be specified as max sourced from a location, and a Kansas City DC be SKU based. However, if the user attempts to implement both Location and SKU max sourcing at the same location, location max sourcing would override SKU max sourcing at that location.

Typically, a user would define a source to be any origin location in an origin-destination pair. When locations manufacture a SKU (via make processes), the origin is also the destination. Therefore, the destination can be a source to consider in the max sourcing evaluation. For example, a make-buy decision to make a SKU or source it from a single location could be made by specifying the maximum number of sources to be one. If the maximum number of sources was specified to be one, it would select either the destination (where the item is made) or another location.

A simple example of max sourcing is now provided. In this example, an item entitled Widget is used at a New York location (resulting in a SKU corresponding to Widget@NewYork). Furthermore, Widget can be made in New York or bought from Chicago or Boston locations. If the user specifies one source for Widget@NewYork there are two ways to solve. The user may include the New York as a possible source to itself via make process. In this implementation, the model selects the source to be either New York, Chicago, or Boston. If New York is selected in the optimization, all SKUs called Widget@NewYork should be made at New York. If one of the other locations is selected in the optimization, Widget@NewYork should be sourced from that location but none of the SKU should be made at New York. In this way, the implementation includes the destination as a possible source. In this example where only one source is specified, the optimal solution gives automatic make/buy decision capabilities. If the user specified two sources, the model would evaluate which two of the three would be best and limit sourcing to those two locations.

On the other hand, the user may implement the max source step so that the make processes at the destination is independent of max sourcing restrictions. In the above described case, the max source optimization will not consider the make process for Widget@NewYork and this make process would not be subject to max sourcing decisions. Acordingly, the SKU, Widget@NewYork is either be sourced from Chicago or Boston. In this case, the SKU may be made at the location, but would only be sourced from one other location.

For both Location and SKU max sourcing, as long as the number of origin locations is correct, there can multiple processes or lanes at those locations. Max sourcing will apply regardless of the number of processes or lanes that connects the origin and destination. This feature also applies to make processes, so if the SKU(s) can be made at the destination location or sourced from another location, a selection of one source would choose only one of the locations. For example, if an item X can be made at New York using several different make processes and can be purchased via multiple purchase processes from Chicago, the maximum number of sources is still one. The max sourcing limitation would select either New York or Chicago, but the optimal solution can use any of the applicable processes at the specified location.

The user should further decide the timing for max source optimzation of the supply chain. Specifically, the user may choose to implement the max sourcing for either the entire time horizon or a limited time period within the time horizon. For the max sourcing over the entire planning horizon, the source would remain the same over the entire planning calendar. For a max source limitation that is implemented for limited time period, the source could change in each time period.

The addition of max sourcing increases the possibility of an infeasible problem where optimization of supply chain cannot be generated. For example, if the location is to be max sourced with a maximum of 1 location, all items must be available from at least one location. Similarly, if the restriction is for X locations, all items must be available from at least one of the X locations. During preprocessing, an optimal solution cannot be produced if every SKU is not available from at least one site within a group of the specified number of locations. The issue of infeasible supply chain optimization is addressed below in step 500.

Continuing with FIG. 2F, as part of defining the problem to be solved, the user may further specify a time frame or planning horizon for the supply chain optimization, step 330. In step 330, the user decides how far into the future to plan. This decision of selecting a time frame is generally based upon the business problem the user is trying to solve. A closer time frame generally offers better accurate predictions but may offer less insight into a problem. Conversely, a distant prediction, although generally inaccurate, may offer valuable information of trends and general results from changes in a supply chain. In an embodiment of the present invention, the user may specify a planning horizon as short as three months or as far into the future as 24 months.

As part of defining the planning horizon, the user may also designate one or more lead-times, step 258. A lead-time is a time duration, such as five days or two weeks, that specifies the amount of time it takes for a product to flow through a business process. Lead-times can be incorporated into any of the processes defined in step 250. The benefit of introducing the lead-times into the supply chain model is to achieve optimal supply chain solutions that better simulate real-world conditions and needs. For example, the user can model a two-week delay in a make process to hold the product before releasing it into the supply chain as a finished good, thereby simulating the time required to manufacture the product within the process. By introducing the concept of the lead-time into a supply chain model, optimization of the model may consider the trade-offs among cost, capacity, and lead-time when determining the optimal minimum cost or maximum profit solution. For example, if a make process requires two weeks to produce a finished good, demand for raw material in the make process appears two weeks before the independent demand for the finished good. Similarly, delivery of a product may be required within a specific time frame, such as a delivery deadline specified in the above-described service levels of step 255.

The use of the lead-time in the determination helps create this complex functionality while preserving an overall simple methodology and design. In particular, the supply chain is generally modeled with the assumption that the amount of a product that enters a process in a given time period enters at the start of that time period. The process lead-time is then added to calculate when the product should be released to the rest of the supply chain (outflow date), regardless of the given time period for the supply chain model.

In one implementation, if the outflow date falls within the first half of a time period (fifty percent or less), the product will be released in that time period. Otherwise, the product is released in the next time period. For example, if the lead-time on a sourcing process is six days and a pair of time periods each lasts a week (seven days), a product that enters the process during a first time period is not released until a second, subsequent time period because the outflow date falls in the second half of the first time period. Conversely, if the time periods are a month (thirty days), the product that enters the process in a time period will be released in that time period because the lead-time is less than half of the time period. As can be seen from the second half of this example, if the lead-time is fifty percent or less than the shortest time period in the planning calendar, the product will never be delayed from one time period to another, and, therefore, the lead-time will not have an effect. For this reason, the user will find lead-times most beneficial if the supply chain has lead-times that are larger than half the length of the time periods in the planning calendar.

For a process with lead-time that results in a delay, the optimization calculates the number of started executions of a process in a time period and the number of completed executions of the process in that time period. If lead-time does not result in a delay, all executions occur in the same period.

The user may, as part of step 258, assign a lead-time offset and a duration value to a resource. The offset specifies when a reusable resource supplies a process, and the duration stipulates how long a resource supplies the process throughout the lead-time. The sum of the resource offset and duration values for the resource may then be used to determine the lead-time for a process. Where there are more than one resource in a process, the process lead-time is equal to the largest lead-time (offset+duration) for a resource that supplies the process.

It is therefore possible for a process to have a first lead-time, and resources used in the process to have a second lead-time. This situation is analogous to a production process that takes some time to complete and uses an input that takes some time to obtain. In this case, the optimization uses the larger of the first or second lead-times. For example, if a process has a lead-time of two weeks and a resource used in the process has an offset of one week and a duration of four weeks, the supply chain is optimized using a five-week lead-time (the offset plus the duration). Conversely, if the process lead-time had originally been set at six weeks, then the optimization would use six weeks as the final process lead-time since six weeks would be the maximum number of weeks needed for the make process.

By using the lead-time offset of the resource requirement, the user may model staged, as well as overlapping reusable resource draws, from a single process. For example, the user may model a three-staged make process that requires the sequential use of resources. In this example, the lead-time for a resource represents a wait for the process to complete using another resource. Otherwise, modeling this supply chain without the use of resource offsets and durations would require the user to specify two extra make processes, two intermediate items, and two intermediate SKUs.

When a resource initiates a process, the resource draw amount is specified in terms of resource draw per execution of the process. If a process has no lead-time, the draw of the resource occurs in the same time period as the execution of the process. If the process has a lead-time, the draw of the resource will be dependent on the lead-time value and the length of the planning periods. Unless the offset and duration is set for a resource, the supply chain is optimized with the assumption that the resource supplies the process throughout the entire lead-time. For example, given a weekly planning calendar and a make process with a three-week lead-time and a labor resource, the resource supplies the process for three weeks if the user does not specify the offset and duration. On the other hand, if the offset and duration are both one week, the resource will supply the process for only the second week of the lead-time.

In another embodiment, the user may coordinate the use of pre-builds (introduced above in step 232) and the lead-times specified in specified in step 240. The use of pre-builds on items enables the user to limit how early product is made or purchased to satisfy demand. A pre-build time fence restricts the number of planning periods that an item can remain in the supply chain before that item arrives at a customer location or is consumed in a manufacturing process. In operation, the time fence operates in conjunction with any lead-times. For instance, when following an item through the supply chain, any lead-time found in the path that the item travels is counted against the pre-build restriction.

Returning to FIG. 2F, the user may further define fixed costs associated with each of the processes, step 259. For instance, the user may identify a service agreement tied to a purchase process or an overhead expense related to a manufacturing process.

Referring again to FIG. 2A, for each of the processes defined in step 250, the user may also define resources needed for the particular process, step 260. Resources are entities that are consumed, used, or produced by the business processes in the user supply chain. As illustrated in FIG. 2G, the user may generally specify the type of resource, step 262, and associate each of the defined resources to one or more locations, step 263. Different types of resources include resources related to storage, labor, machinery, production, material conversion, in-handling (associated with receiving goods), and out-handling (associated with shipping goods). For example, a typical make process defined for a particular location may use labor resources and consumes storage resources, while necessitating a storage resource for a finished good. In defining transportation resources, the user may associate these resources with lanes defined in step 220. The user may further specify other characteristics that define the resource, step 264, such as a unit of measure and a price for each resource.

In one preferred implementation of the present invention, the user may define tiered pricing for one or more of the resources, step 265. Tiered pricing refers to changes in prices or costs for a resource with changes in the quantity purchased or sold of that resource. The tiered pricing may be used to model real-world features such as plant opening/closing decisions and load leveling. The user may also model increasing economies of scale. For example, the following Table 1 shows a resource having a decreasing unit price with increased purchase quantity.

TABLE 1

| Purchase Quantity | Price/Unit |
|---|---|
| 1-10 | $10.00 |
| 11-20 | $7.00 |
| 21-30 | $4.00 |
| 31-40 | $1.00 |

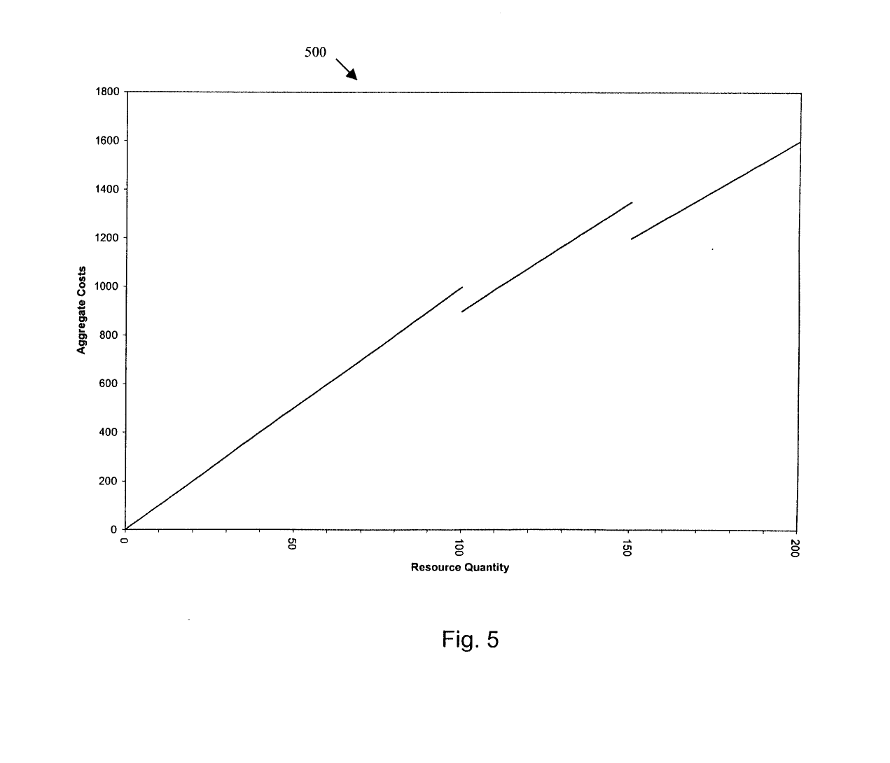

Given a multi-tiered pricing table, there are two ways of calculating total cost/price for a resource. If the user uses a step function cost structure to represent the unit cost, as exemplified in the following Table 2, the cost calculating is directly determined. The tiered pricing/costing defined in Table 2 produces a total cost curve that has a structure as illustrated in graph 500 in FIG. 5. Graph 500 is distinguished by the presence of steps, or jumps, in prices or costs with changes in the quantity of the resource. In this example, the costs for any unit of a resource change as the quantity of those resource changes. As can be seen in FIG. 5, it may cost less to purchase a greater amount of the resource.

TABLE 2

| Quantity/Month | $'s/Unit | Cost |
|---|---|---|
| First 100 | $10.00 | e.g., 100 Units: |
| | | $1000 |
| Second 50 | 9.00 | e.g., 150 Units: |
| | | $1240 |
| After 150 | 8.00 | e.g., 180 Units: |
| | | $1440 |

Conversely, the user may design the cost/price structure to calculate total cost on a cumulative basis, as in the following Table 3. In this situation, the costs for additional units of resource change with increased quantity.

TABLE 3

| Quantity/Month | $'s/Unit | Cost |
|---|---|---|
| 1-10 | $10.00 | e.g., 10 Units for $100 |
| 11-20 | 7.00 | e.g., 20 Units for $170 |
| 21-30 | 4.00 | e.g., 30 Units for $210 |
| 31-40 | 1.00 | e.g., 40 Units for $220 |

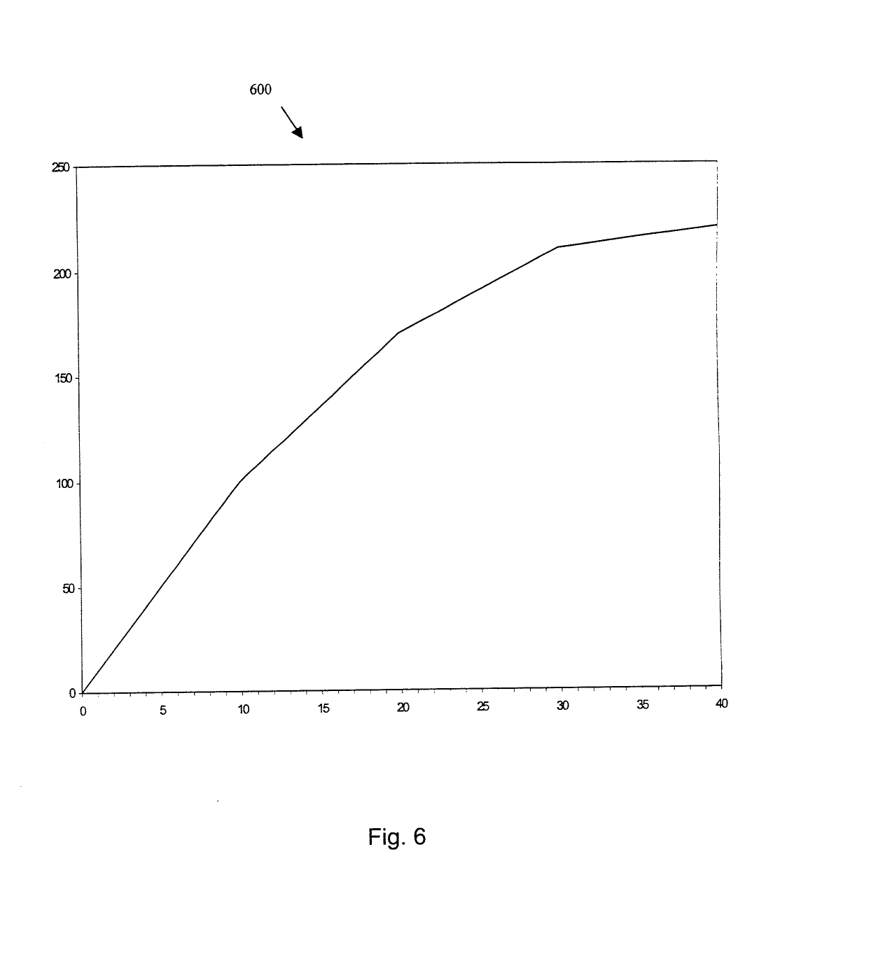

This type of cost calculating is called a cumulative cost calculation. As illustrated in graph 600 in FIG. 6, the total cost curve for a cumulative cost curve does not have jumps or steps, but instead has changes in slopes at key points where the cost for additional units changes.

In another type of tiered pricing structure, a constant cost is be added to the “Per Unit” cost. At each tier, the equation for determining the total cost or price is:

Y=UX+B, (Equation 10)

where Y is the total cost, U is the per unit cost, X is the quantity of the resource, and B is the constant cost. A constant cost may be added to either the direct or cumulative approach of calculating costs. The B, or batch cost, represents an additional cost for obtaining/producing a resource. For instance, if there is a maintenance charge of $1,000 for every 500 hours of machine use, this is a flat charge for a range of volume (every 500 hours) that cannot be accounted for with just a cost per unit figure. As part of the tiered functionality, the batch cost is added to the variable equation to account for this type of cost.

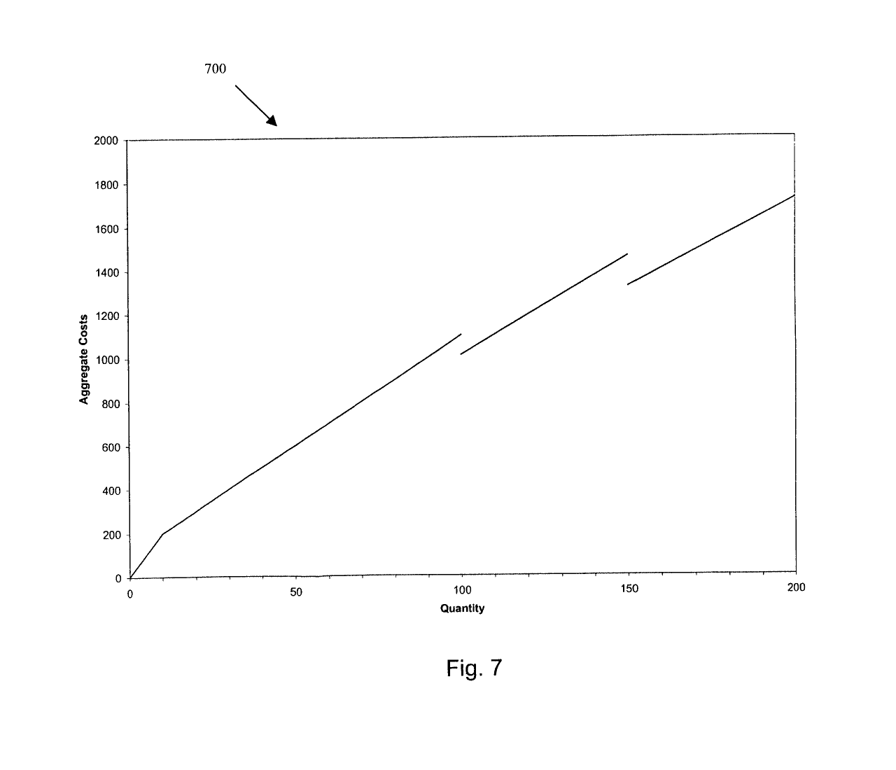

The cost calculation using a direct approach with the addition of constant costs is illustrated in Table 4. The multi-tiered pricing structure of Table 4 produces a price total cost curve having a structure as illustrated in graph 700 in FIG. 7. FIG. 7 shows that the total price curve is similar to FIG. 5, but vertically shifted.

TABLE 4

| Quantity/Month | Constant $'s | $'s/Unit | Cost |
|---|---|---|---|
| First 100 | $100 | $10.00 | e.g., 100 Units: |
| | | | $1100 |
| Second 50 | $110 | 9.00 | e.g., 150 Units: |
| | | | $1460 |
| After 150 | $120 | 8.00 | e.g., 180 Units: |
| | | | $1560 |

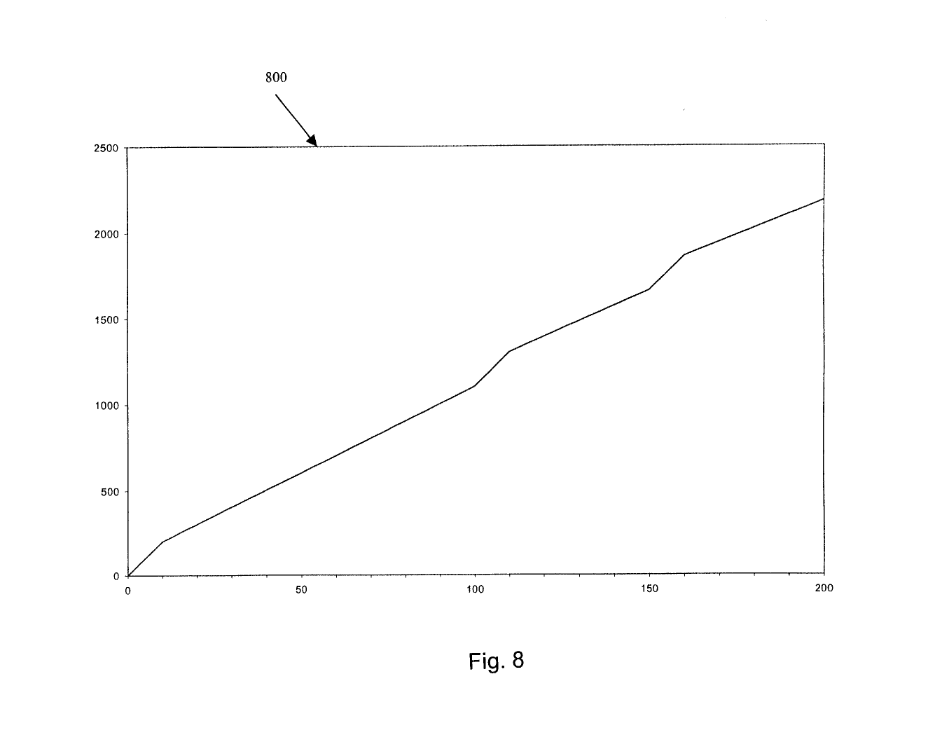

Similarly, an example of constant costs with the cumulative pricing approach using the same constant costs is given in Table 5. The multi-tiered pricing structure of Table 5 produces a price total cost curve as illustrated in graph 800 in FIG. 8.

TABLE 5

| Quantity/Month | Constant $'s | $'s/Unit | Cost |
|---|---|---|---|
| First 100 | $100 | $10.00 | e.g., 100 Units: |
| | | | $1100 |
| Second 50 | $110 | 9.00 | e.g., 150 Units: |
| | | | $1660 |
| After 150 | $120 | 8.00 | e.g., 180 Units: |
| | | | $2020 |

Therefore, a user creates a multi-tiered pricing structure by specifying multiple per unit costs/prices, the quantity levels at which this per unit costs operate, any batch costs, and indication of whether the tiered pricing is determined using the direct or cumulative methods. The computation of optimal solutions in a supply chain having tiered pricing is described in great detail below in the discussion of step 400.

Returning to FIG. 2G, the user may add additional constraints to the supply chain model, step 267. These constraints are added to the supply chain network to model finite capacity of resources and various quantity limitations on SKUs. The user may implement hard constraints that cannot be violated and soft constraints that can be violated, at a cost, if necessary to achieve optimal configurations of the supply chain. Examples of hard and soft constraints that may be implemented in a supply chain model include: minimum reusable resource capacity, maximum reusable resource capacity, minimum SKU inflow amount, maximum SKU inflow amount, SKU safety stock, SKU maximum on hand at a location, minimum SKU outflow amount, maximum SKU outflow amount, independent SKU demand, maximum SKU demand, minimum reusable lane capacity, maximum reusable lane capacity, and supplying percentage constraints.

The user may implement hard constraints to model situations in which the constraints must not be violated. For example, the user may wish to model a machine resource with a maximum capacity that cannot be increased at a plant, regardless of the cost. If the user sets the maximum constraints to hard, the optimal solutions to the supply chain cannot violate these constraints.

As described above, soft constraints are constraints that may be violated in order to achieve a feasible and optimal plan in a supply chain model. If possible, the supply chain should be optimized without violating any of the soft constraints. In defining a soft constraint, the user assigns an associated penalty cost. The penalty cost adds an incremental cost per unit for violating the constraint. Even if the user specifies an extremely large penalty cost, the soft constraint is still different from a hard constraint in that the soft constraint may be violated in order to achieve a feasible, optimal solution to the supply chain model. For example, if a reusable resource has a maximum capacity constraint of 50 hours and a penalty cost of $1,000/hour, then a supply chain configuration that uses 75 hours of a resource would have a total penalty of $25,000 (75 hours−50 hours) * $1 000/hour.

If more than one soft constraint may be violated to produce an optimal supply chain configuration, the soft constraint with the smallest penalty cost is generally violated first. Therefore, penalty costs are a means of ranking the importance of soft constraints in the supply chain network.

If the user defines both a hard constraint and a soft constraint for a resource or SKU, the aggregate constraint is assumed to be hard. For example, if the user's only plant location has a soft minimum or maximum constraint on the amount of output for a SKU, and a customer location has a hard, minimum constraint of that SKU to receive, the plant may not output less than the amount needed at the customer location.

When defining constraints in step 267, the user should be careful to avoid creating a mixture of hard constraints that combines to create an infeasible problem. For instance, if the user creates a manufacturing resource with a hard minimum constraint that requires production of a manufacturing process at a plant to be at least 50 kg/month and a transportation resource with a hard maximum constraint of 20 kg/month that ships product from the plant to other locations, no configuration of the supply chain may satisfy both of these requirements. In particular, since the minimum production is greater than the maximum transportation capacity, no feasible solution exists. If one of the constraints was soft, a feasible solution may be achieved. Thus, in situations resulting in infeasible solutions, the user should redefine one or more of the hard constraints to determine which one to relax and set to soft.

However, the use of hard constraints has important computational advantages in that the hard constraints are easier to model and compute. As described in greater detail below, the constraints in the supply chain network are converted into linear equations. When a constraint is soft, an extra penalty variable is created to hold the value of how much a proposed solution violates the soft constraint. As the number of soft constraints in the network grows, so does the number of penalty variables. The hard constraints do not require penalty variables, and, as a result, the use of hard constraints degrades the processing overhead through the memory requirement of generating extra constraints and variables.

Returning to FIG. 2G, in another implementation of the present invention, the user may define a dimension number for the resources, step 268. One-dimensional resources are consumed in terms of a single unit of measure. These types of resources include in-handling, labor, machinery, material conversion, out-handling, production, and transportation resources. The units of measure for these resources may be hours, pounds, feet, kilograms, etc. For example, a labor resource might be priced and consumed in terms of hours, and the utilization would be expressed in hours. Costs for the labor resource are then determined by multiplying the unit hourly cost for labor by the number of hours consumed.

For example, suppose a make process requires 10 hours of a labor resource to produce 20 kg of a SKU. The labor resource utilization then equals the demand for SKU divided by the SKU requirement times the labor resource requirement. Therefore, if 100 kg of the SKU are needed in the supply chain, 50 hours (100/20*5 hrs) of the labor resource are needed in the supply chain. If the labor costs $5 per hour, then the labor resource needed to produce the 100 kg of the SKU costs $250 ($5/hr *50 hrs). The supply chain may further have a maximum limit for any resource, where the limited can be exceeded only with a high resource cost. The concept of capacity is described in greater detail above in the description accompanying step 267. The total penalty cost equals the resource penalty cost times the difference of the actual labor resource utilization minus max capacity. For example, if the maximum amount of labor resource in the above described supply chain is 10 hrs and the cost for additional hours is an additional $10 per hour, then the cost for the labor resource becomes the $250+ an additional $500 (50 hours−10 hours)*$10), or a total of $750.

In contrast, two-dimensional resources add a second element to consumption of the resource. Typically, these two dimensional resources are consumed in terms of a unit of measure and a duration of time. For example, inventory resources may be described as two-dimensional. For inventory resources, a quantity such as pallets, pounds, or square feet is consumed over a period of time such as days, weeks, or months. An inventory resource can be used to determine the inventory carrying cost of a SKU or as a resource that is drawn by a make process. For inventory carrying cost of a particular SKU, the user multiplies the ending inventory in each planning period by the cost per day of its designated inventory resource and the number of days in the planning period. To incorporate a two-dimensional inventory resource, the supply chain model should further include a duration value to account for time measurements. In particular, inventory resource utilization for the SKU may be defined as the product of the inventory resource requirement and the inventory resource duration in the make process times the ratio of the total required amount of the SKU and the amount of the SKU produced in the make process.

Returning to the previous example, the total required amount of the SKU is 100 kg, and the amount of the SKU produced in the make process is 20 kg, thereby requiring 5 cycles of the make process to meet the demand for the SKU. If the inventory resource requirement for the make process is 10 kg per cycle and the inventory resource duration is 7 days per cycle, then the total required amount of the inventory resource is then 10 kg*7 days *(100 kg/20 kg), or 240 kg-days. If the planning period of the supply chain model is 30 days, then the average amount of storage resource required is 240 kg-days/30 days, or 11.7 kg. Similarly, if the storage resource has a cost of $20/kg-day, then the total cost for the storage resource in the example is 240 kg-days*$20/kg-day, or $7000.

Where the supply channel model provided by the user has several different processes, the inventory resource usage at each location may be found by summing the inventory resource usage from each process.

When modeling an inventory resource, the user should further consider a maximum inventory capacity defined in step 267 that represents the maximum available amount of the inventory resource. Generally, inventory capacity is constant over the entire planning period, and inventory consumption cannot exceed capacity at the end of the time period. At the same time, the inventory resource automatically renews to represent the opening of space as items are moved away from a location. This feature of the inventory resources differs from the other types of resources that are depleted as soon as they are consumed and cannot be replenished without some other operation, such as a purchase process. Exceeding the inventory capacity may have undesired results or costs that should be considered when determining optimal solutions for the supply chain. To introduce and enforce the inventory capacity in the supply chain model, the user may specify an inventory penalty cost as part of step 267. The inventory penalty cost represents the cost of exceeding the inventory capacity, such as obtaining additional inventory space. The total penalty cost may be found by multiplying the excess use of inventory (i.e., average inventory utilization minus inventory) by the duration of the planning period and the daily penalty cost. For example, if the capacity in the previous example was 10 kg-day and the inventory penalty was $10/kg-day, then the total penalty cost would be (11.7 kg-day−10 kg-day)*30 days*$10/kg-day, or $510.

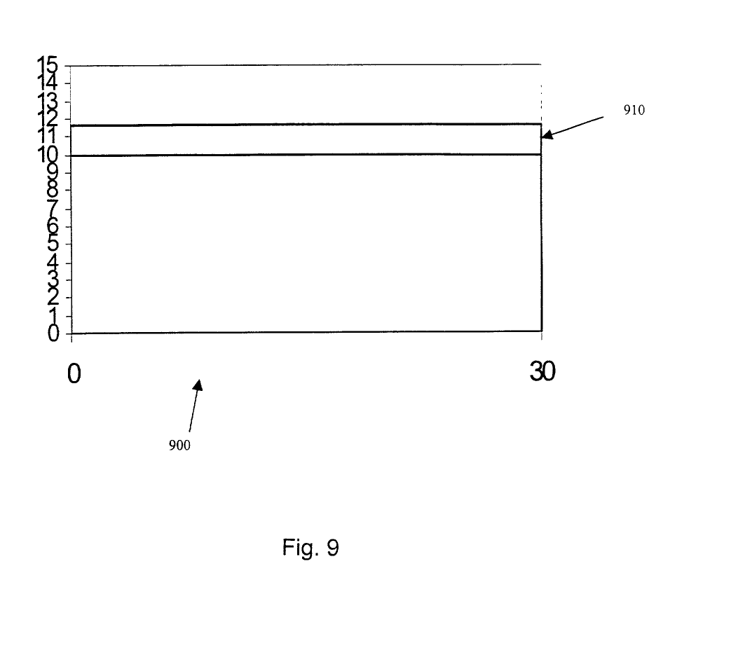

This inventory penalty is schematically illustrated in FIG. 9 having a chart 900. In the chart 900, a vertical axis represents amounts of the inventory resources, and the horizontal axis represents the number of days in the planning period. The chart 900 further contains a shaded region 910 that represents the excess inventory resource usage of 11.7 kg/day, above the capacity of 10 kg/day. The total amount of excess inventory usage in the planning period (thirty days in this example) is then the area of the shaded region. Consequently, the total penalty for the excess inventory is equal to the area of the shaded region multiplied by the cost-per-unit of exceeding the inventory capacity.

Returning to FIG. 2G, the user may further define fixed costs associated with each of the resources, step 269. For instance, the user may identify depreciation in a particular machine, charges for supervision of labor, maintenance fees for production resources, etc. These types of expenses occur, regardless of the configuration for the operation of a supply chain.

Returning to FIG. 2A, another embodiment of the present invention allows the user to specify tax and tariff information, step 270. The user may supply this information, or the information may be obtained from a third party. Then, during optimization of the supply chain, the tax and tariff information may be used to modify the cost values otherwise defined in step 200. This functionality allows the user to find optimal supply configurations involving international locations. Specifically, the user may specify tariffs and taxes that are associated with a location that may not otherwise be incorporated into the supply chain model. The tax/tariff value generally represents a cost for moving a unit to and from a location. While the tax/tariff data may be initially specified as part of the definition of processes at a location in step 250, the ability to separately define the tax and tariff allows the user to isolate these costs during an analysis of the supply chain. Furthermore, the ability to separately define the tax and tariffs allows the user to easily change these values as needed to adjust for changes in rates and location.

As depicted in FIG. 2H, the data used to define the supply chain model in steps 210-260 may be created by the user, step 201, or imported from an outside data storage location such as a database, step 202. Alternatively, the user may import data from a previously defined supply chain, step 203, or use default, pre-defined values 204. Also, the user, after previously defining a portion of the supply chain, such as a location, process, resource, or skew, may specify new portions of the supply chain by copying the information from the previously defined portions of the supply chain and modifying this information, step 205. For example, the user may define a second location by copying the data for the first, previously defined location and changing the geographic information for the second location. In this way, the user may easily create a second location having the same SKUs, processes, and resources as a first location.

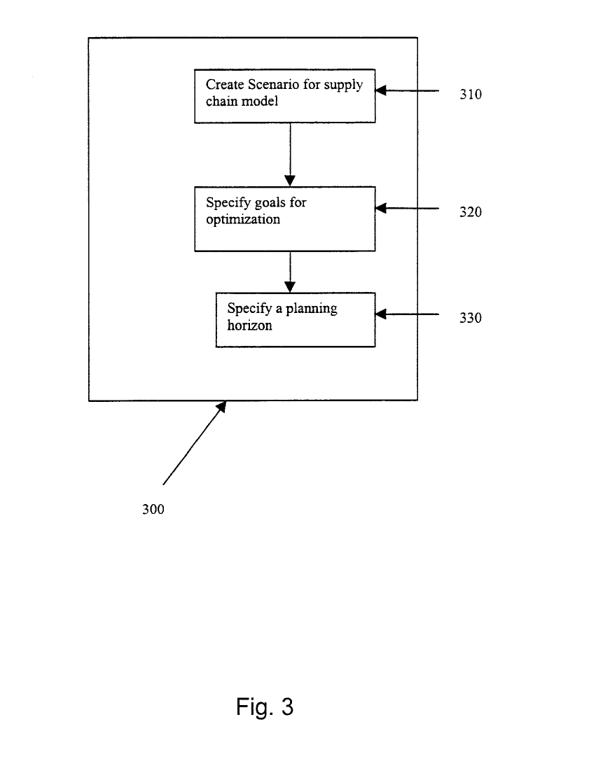

Returning to FIG. 1, after the user has defined the supply chain model in step 200, the user defines the optimization conditions, step 300. As illustrated in FIG. 3, the user may first create a scenario while defining a goal for the optimization of the supply chain model, step 310. In one scenario, the user modifies one or more of the elements of the supply chain model and then computes the results of these changes to the supply chain. In this way, the user may predict the results of any changes to the supply chain, such as adding items, locations, lanes, or processes.

There are many potential uses for scenarios defined in step 310. For example, the user may create a supply chain network that models the demand for a SKU during a peak period, when the SKU is purchased by several customers. To model the demand, the user may create customer locations and link them to DCs by purchase processes. While the user's general objective for the supply chain model may be minimizing the cost of supplying the SKU to the customers, the user may modify the supply to create a scenario in which better service is provided to a customer. For example, the user may have a large-volume customer that requires an adequate supply of SKU during the peak period. The user may then create a scenario in which the large-scale customer always receives an adequate supply of the SKU, even if the user needs to pre-build and store an amount of the SKU, thereby incurring substantial pre-build and storage costs. The user may further become unable to meet delivery requirements for other customers. To create this scenario, the user modifies the supply chain model by creating or setting a higher penalty cost for not meeting the large-scale customer's demand and a lower penalty cost for not meeting the demand of other customers.

Returning to FIG. 3, the user specifies goals for the optimization of the supply chain, step 320. For example, the user may choose to minimize costs or to maximize profits or sales volumes. Alternatively, the user may define a business problem to solve, such as optimizing a supply chain network to lower the transportation and inventory costs. It should be appreciated that the user may specify other goals for the optimization of the supply chain such as improving delivery times or the expansion of sales volumes, but the enumeration of the numerous possible optimization goals is beyond the scope of the present disclosure.

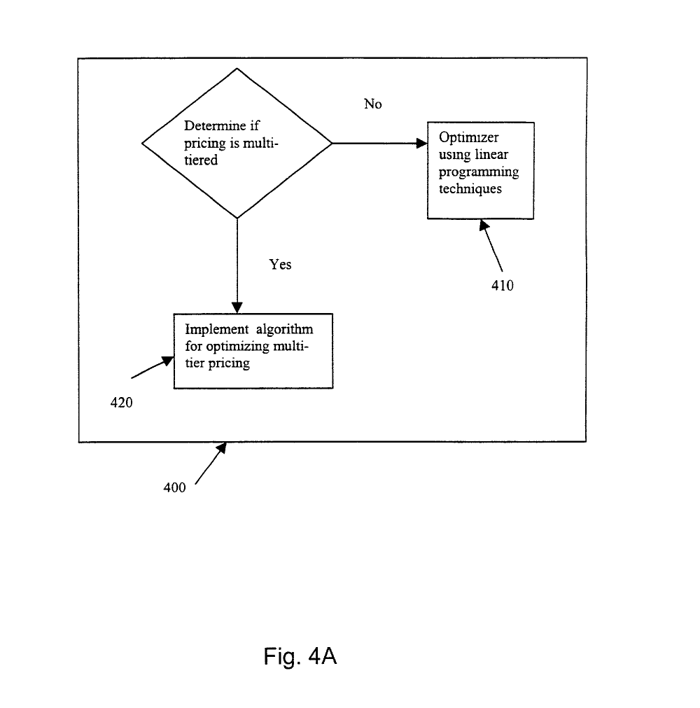

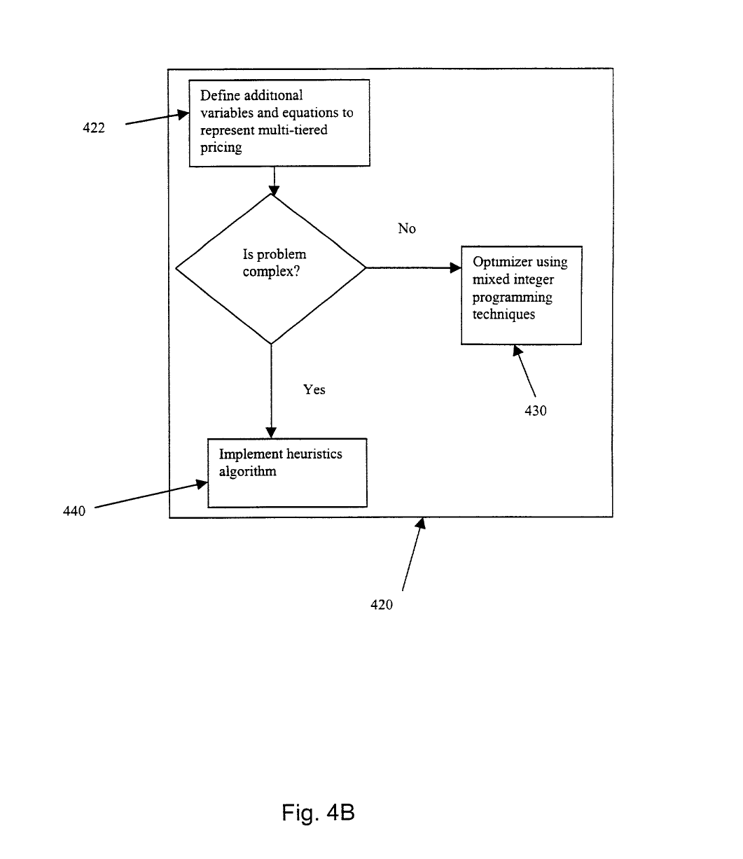

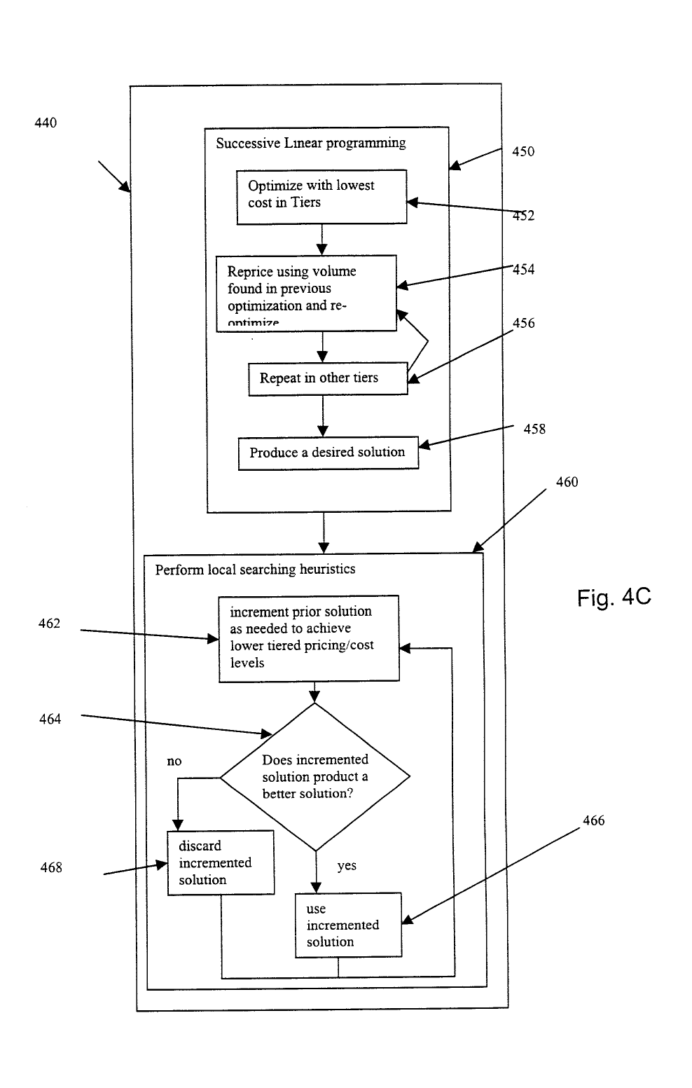

Returning to FIG. 1, after defining the supply chain model, step 200, and specifying the conditions for optimization, step 300, the user optimizes the supply chain, step 400. As illustrated in FIG. 4A, the data from step 200 is analyzed in view of the constraints defined in step 300, step 410, using any known operation research, statistics, data processing, or heuristic techniques. In a preferred embodiment, the supply channel model is optimized using known a combination of known linear programming (LP) and mixed integer programming techniques.

In one implementation, the data provided by the user in steps 200 and 300 are combined to define variables created for the planned executions of a make, purchase, or sourcing process. Specifically, the cost of each plan execution is calculated as the sum of the products of reusable resource requirement and reusable resource cost and the products of SKU requirement and SKU purchase price. In a maximum profit scenario, the revenue is gained from selling. The revenue gained for each execution of the purchase process is the unit price of the SKU multiplied by the SKU requirement amount.

The operations of the processes are limited or modified by the inputs of step 300, such that the optimization may be limited by the goals of step 310, the scenarios of step 320, the time constraints of step 330, the lead-times of step 258, and the inventory requirements established in step 240.

Returning to FIG. 4A, if the user has specified a tiered pricing (or costing) structure for one or more resources in step 265, the optimization of the supply channel is performed using a slightly modified process, step 420. This modified computational process 420 is described in FIG. 4B. For example, multi-tiered pricing may be modeled through use of additional equations and variables, step 422. For instance, a ResourceUtilization variable and a Resource Balance equation for each reusable resource may be created during optimization. The ResourceUtilization variable is the sum of the planned execution calendars of each process using the resource multiplied by the resource requirement amount, where the objective coefficient of the ResourceUtilization variable is the reusable resource cost.

Similarly, an InventoryResourceUtilization variable and an Inventory Resource Balance equation for each inventory resource may be created during optimization. The InventoryResourceUtilization equals the sum of the available, on-hand inventory using the inventory resource multiplied by the inventory resource requirement amount and number of days and the sum of the planned executions of each process using the inventory resource multiplied by the resource requirement amount and number of days. The objective coefficient of the InventoryResourceUtilization variable is the inventory reusable resource cost. Also created during optimization are a SupplyUtilization variable and a Supply Balance equation for each supplier SKU with multi-tiered unit price. The SupplyUtilization variable is defined as the sum of the purchase process inflow executions (excluding the purchase processes with their own price) multiplied by the SKU requirement amount. The objective coefficient of the SupplyUtilization variable is the supplier SKU unit price. Optimization may further create a DemandUtilization variable and a Demand Balance equation for each customer SKU with multi-tiered unit price and some of the SKU's purchase processes have their own price. The DemandUtilization variable is the sum of the purchase process outflow executions (excluding the purchase processes with their own price) multiplied by the SKU requirement amount, and the objective coefficient of the DemandUtilization variable is the customer SKU unit price. With these additional variables and equations, the planned execution variables of make and sourcing processes no longer have cost coefficients in the objective function. The planned execution variables of the purchase process has cost coefficients in the objective function if the purchase process has unit price set or if the customer SKU unit price is not set.

Looking at the pricing functions in FIGS. 5-8, it is clear that the objective function of the multi-tiered pricing problem is not linear. The problem has a piecewise linear function in the objective function, and as a result the result problem can not be solved using standard linear programming techniques. The problem with using just LP to solve the multi-tiered pricing problem is that the cost of each activity is variable until the amount of production and transportation is known. Thus, optimization start with cheapest cost, a solution is produced using this cost to solve a LP, and then costs are recalculated based on the LP solution. The process continues until the solution converges or the number of iterations reaches a pre-determined limit. Because of the complexity of the supply chain network, the solution may oscillate, and no convergence is guaranteed. Even if the solution converges, it may not be the optimal solution.

Returning to FIG. 4B, mixed integer programming (MIP) and heuristic techniques may be used to optimize the supply chains having multi-tiered pricing. MIP is a modified linear programming technique in which some variables are restricted to integer values. In this way, the supply chain model is solved with branch and bound algorithm. Using some integer variables to represent the varying price segments, the optimization of a supply chain having multi-tiered pricing can be formulated as a MIP problem, step 430. This approach provides optimal solutions but generally requires a relatively large number of calculations that become prohibitive for large-scale problems. On the other hand, LP-based heuristics may be used to determine optimal solutions to optimize a supply chain having multi-tiered pricing, step 440. The heuristic techniques used in step 440 form acceptable solutions using a manageable, relatively smaller number of calculations.

The MIP process in step 430 uses a z(x) function that denotes the contribution of x to the objective function. The values q₁, where 0<q₁<q₂< . . . <qᵣ₋₁<∞ are the points where z(x) changes slope, such that there are r tiers. In the interval qᵢ₋₁<=x <=qᵢ, the slope is c₁, for i=1 to r, where q₀=0, qᵣ=∞. In other words, cᵢ is the cost/unit of the i^{th} tier. Furthermore, bᵢ represents the batch or constant cost of the i^{th} tier, for i=1 to r. Then, the non-negative variable x₁ corresponds to the value for x, if x exceeds 0 but is less than or equal to q₁. Likewise, x equals x₂ if x exceeds q₁ but is less than or equal to q₂, x equals X₃ if x exceeds q₂ but is less than or equal to q₃, and so on. The Boolean variable w₁ equals 1 if x within the interval of 0 to q₁ and otherwise equals 0. Likewise, w₂=1 if q₁<=x <−q₂ and otherwise W₂=0; W₃=1 if q₂<=x<=q₃ and otherwise W₃=0; and so on. In this way, the binary variable wᵢ indicates whether the i^{th} tier is used.

In the direct approach formulation, the cost curve is a step function, as described above in the discussion of step 265. Accordingly, the direct approach formulation can be expressed as:

z(x)=c₁x₁+b1w1+c₂x₂+b₂w₂+c₃x₃+b₃+ Equation 11

where

1) x=x₁+x₂+X₃+ . . . ;

(2) x₁≦q₁w₁;

3) qⱼ₋₁wⱼ≦Xⱼ≦qⱼwⱼ given 2≦j≦r−1;

4) qᵣ₋₁wᵣ≦Xᵣ≦Mwᵣ given M is a very big constant; and

5) W₁+ . . . +Wᵣ≦1.

### EXAMPLE 2

The MIP model can be used to represent the direct approach cost structure of the following Table 6 (identical to previous Table 4).

TABLE 6

| Quantity | Constant Costs | Costs/Unit | Aggregate Cost |
|---|---|---|---|
| First 100 | $100 | $10.00 | e.g., 100 Units |
| | | | cost: $1100 |
| Second 50 | $110 | 9.00 | e.g., 150 Units |
| | | | cost: $1460 |
| After 150 | $120 | 8.00 | e.g., 180 Units |
| | | | cost: $1560 |

Using the above-described direct approach formulation,

Total Cost=10x₁+100w₁+9x₂+110w₂+8x₃+120w₃;

and

Total Quantity=x₁+x₂+X_{3,}

where

1) x₁≦100w₁;

2) 100w₂≦x₂≦150w₂;

3) 150w₃≦X₃≦Mw₃(M is a big constant);

4) W₁+W₂+W₃≦1;

5) x₁, x₂, X₃≧0;

6) x₁≦100;

7) x₂≦150; and

8) w₁, w₂, w₃=0 or 1.

In contrast to the direct approach, the cumulative approach formulation in the MIP approach in step 430 may be expressed as:

z(x)=c₁x₁+b₁w₁ (Equation 12)

+c₂x₂+[(c₁−c₂)q₁+b₁+b₂]w₂

+c₃x₃+[(c₁−c₂)q₁+(c₂−c₃)q₂+b₁+b₂+b₃]w₃+ . . .

where

1) x=x₁+x₂+x₃+ . . . ;

2) x₁≦q₁w₁;

3) qⱼ₋₁wⱼ≦xⱼ≦qⱼwⱼ given 2≦j≦r−1;

4) qᵣ₋₁wᵣ≦xᵣ≦Mwᵣ given M is a very big constant; and

5) w₁+ . . . +wᵣ≦1.

### EXAMPLE 3

The MIP model is used to represent the cumulative approach cost structures of Table 7 (identical to previous Table 5).

TABLE 7

| | Constant | | |
|---|---|---|---|
| Quantity | Costs | Costs/Unit | Aggregate Cost |
| First 100 | $100 | $10.00 | e.g., 100 Units cost: $1100 |
| Second 50 | $110 | 9.00 | e.g., 150 Units cost: $1460 |
| After 150 | $120 | 8.00 | e.g., 180 Units cost: $1560 |

Using the above-described cumulative approach formulation,

Total Cost=10x₁+100w₁+9X₂+[(10−9)100+100+100]w₂ +8x₃+[(10−9)100+(9−8)150+100+110+120]w₃=10x₁+100w₁+9x₂+310w₂+8x₃+580w₃;

and

Total Quantity=x₁+X₂+X₃,

where

1) x₁≦100w₁;

2) 100w₂≦x₂≦150w₂;

3) 150w₃≦x₃≦Mw₃(M is a very big constant);

4) w₁+w₂+w₃≦1;

5) x₁, x₂, x₃≧0; and

6) x₁≦100;

7) X₂≦150;

8) w₁, w₂, w₃=0 or 1.

Accordingly, a supply chain having multi-tiered pricing may be modeled using MIP as a series of linear equations. The series of linear equations can be incorporated in known optimization techniques, such as LP, in step 410. As can be seen in Examples 1 and 2, a MIP problem quickly grows in size.

Returning to FIG. 4B, supply chains having multi-tiered pricing may use heuristics to solve the optimization problems, step 440. More specifically, as illustrated in FIG. 4C, the multi-tiered pricing problem may be solved through the combination of two heuristics techniques, Successive Linear Programming, step 450, and Local Search, step 460.

As illustrated in FIG. 4C, Successive Linear Programming (SLP) in step 450 is used to find a good initial solution. Typically, the optimization starts with the lowest cost in the tiered costs. Using the lowest cost, the supply chain is optimized with LP to get a first solution. step 452. The costs are then changed to the tier corresponding to volume levels produced in the first solution using the lowest price level, and the system is re-optimized using the new cost level in LP to get a second solution, step 253. This process of using costs associated with volumes from a previous solution is repeated for several iterations to produce an initial solution, step 456.

Continuing with FIG. 4C, once the initial solution is determined in step 458, local searching heuristics is performed in step 460 to improve the solution by taking advantage of any volume discounts. Local search is an iterative improvement technique to explore the solution space. A search proceeds by sequential improvement of problem solutions, advancing at each step from a current solution by modifying one or a few of the corresponding decisions to a better objective neighbor. In a multi-tiered pricing supply chain, an initial solution may be improved by increasing resource usage or SKU purchased quantity to a better discount level. By forcing some resource usage increase, the LP solver will consolidate different activities to take advantage of a better discount level, which could result in a better solution. Accordingly, in local searching, resource usage is incrementally increased to reach the next successive higher discount level, step 462. If the resource or SKU has no usage, the current price is set to the unit price of the cheapest tier (for resources or purchasing SKUs) or the unit price of the most expensive tier (for selling SKUs). The supply chain is then assessed using this incremental solution, step 464. If an incremental increase produces a solution that is the optimization objective, then the new solution is used, step 466. Incrementation of the supply chain solution is repeated and the new solution is assessed. If an incremental increase produces a solution that is either infeasible or has worse objective value, then discard the changes, step 468.

Where more than one unit has multi-tiered pricing, the heuristics process of step 440 is repeated on other resources until all multi-tiered costs/prices are considered.

Examples of optimization in supply chain having multi-tiered prices/costs are now provided.

### EXAMPLE 3

A supply chain has one DC, one customer, and two transportation links between the DC and the customer. Both transportation links have the multi-tiered costs. Transportation resource A has costs as defined in Table 8, and transportation resource B has costs as defined in Table 9.

TABLE 8

| Quantity | Unit Cost |
|---|---|
| >=0 | $10 |
| >=200 | $8 |
| >=500 | $5 |

TABLE 9

| Quantity | Unit Cost |
|---|---|
| >=0 | $12 |
| >=150 | $9 |
| >=300 | $7 |

In this supply chain, the customer has demand of 180 units of the item, and the DC has enough supply of the item in inventory. The supply chain is defined using two purchase processes, a first utilizing the transportation resource A and a second using the transportation resource B. To ship one unit of the item requires either one unit of transportation resource A or one unit of transportation resource B. The goal of the optimization is to minimize the transportation costs, so the objective function for this optimization is:

Minimize (Cost_A*Ship_A)+(Cost_B*Ship_B).

The minimization is performed in view of the following constraints:

1) Met_Demand=180; and

2) Ship_A+Ship_B=Met_Demand)

If the multi-tiered costs are calculated using direct cost, the SLP heuristics will be like the following iterations.

A first iteration uses the last tier costs as the costs for transportation. Specifically, the unit cost of resource A is set to $5 and the unit cost of resource B is set to $7. The objective function for iteration 1 is then:

Minimize [5*Ship_A+7*Ship_B]

The solution of the objective using LP and the solution of this problem is

Ship_A=180, and

Ship_B=0

since there is no point at which it is advantageous to use transportation resource B instead of transportation resource B. This solution provides an objective function value of 5*180+7*0*, or $900.

However, according to Table 8, the use of 180 units of the transportation resource A has a unit cost of resource A of 10. The objective function is modified to reflect this cost of $10 per unit of transportation resource A. The actual cost of this configuration (using 180 units of transportation resource a) is $1800.

A second iteration of the SLP is performed using the updated price per unit for transportation resource A. The unit cost of resource A is set to $10 and the unit cost of resource B is set to $7. The objective function for iteration 2 is

Minimize (10*Ship_A+7*Ship B).

Through LP, the optimal solution for this objective function is located at

Ship_A 0; and

Ship_B 180.

This solution produces an objective function value of $1260. Since 180 units of the transportation resource B are used, the unit cost of transportation resource B will be updated to $9, as defined in Table 9. Therefore, the actual cost of this configuration is $1620.

A third iteration of SLP may be performed using this new per unit cost for transportation resource B. In this third iteration, the unit cost of resource A is kept at $10 and the unit cost of resource B is set to $9, resulting in this objective function:

Minimize (10*Ship_A+9*Ship_B)

Solving the LP results in a solution in which:

Ship_A=0, and

Ship_B=180.

The objective value for this solution is $1620. Since 180 units of the transportation resource B are used and the cost for resource B is $9 correctly reflect the amount shipped, the SLP algorithm stops. The total cost of this configuration is then $1620.

Continuing with the local search heuristic concludes that this solution is optimal. In particular, lower priced tiers of transportation resource A and transportation resource B are unattainable, so the solution cannot be modified to produce a more optimal solution.

Conversely, if the multi-tiered costs are calculated using cumulative cost, the SLP heuristics will result in the following iterations.

A first iteration assumes the cheapest average costs as the costs for transportation. The unit cost of resource A is set to $5, and the unit cost of resource B is set to $7. Accordingly, the objective for the first iteration is

5*Ship_A+7*Ship_B

Solving this objective using LP produces a solution for this problem in which:

Ship_A=180,

Ship_B=0,

and the overall objective value is 900. Since 180 units of the transportation resource A are used, the average unit cost of resource A is $10 and the actual cumulative cost for resource A is $10*180=$1800.

Setting the unit cost of resource A to $10, the objective for a second iteration becomes:

10*Ship_A+7*Ship_B.

Solving the LP produces a solution of this problem in which

Ship_A=0,

Ship_B=180, and

the objective value is 1260. Since 180 units of the transportation resource B is used, the cumulative cost for resource B according to Table 9 is $12*150+$9*30, or $2070. The average unit cost of resource B is $11.5 (2070/180), so the unit cost of resource B is set to $11.5.

In a third iteration (using the new unit cost for resource B), the objective for iteration 2 is

10*Ship A+11.5*Ship_B.

Solving the LP produces a solution in which

Ship_A=180

Ship_B=0,

and the objective value is 1800. Since 180 units of the transportation resource A are used, the cumulative cost for resource A is $10*180, or $1800. The average unit cost of resource A is still $10, equal to the presently set price per unit for resource A. Because the unit cost for the resources did not change, the SLP algorithm stops at this point.

Again, continuing with the local search heuristic concludes that this solution is optimal. In particular, lower priced tiers of transportation resource A, and reaching a lower priced tier for resource B results in a non-optimal solution have increased optimization costs. Therefore, the solution cannot be modified to produce a more optimal solution.

The above-described MIP and heuristic techniques may likewise be performed to optimize supply chains having maximum sourcing limitations, as described above in step 256. Specifically, the MIP and heuristic techniques of step 420 are used because the maximum sourcing limitations produce non-linear problems where the costs/prices for processes may “jump” according to the changes in the sources for an item.

Returning to FIG. 1, after completing the optimization in step 400, the user evaluates the suggested optimal configurations for the supply chain, step 500. The user may determine the feasibility of the suggested configurations. The user may further verify that all of the specified supply chain requirements are satisfied in the proposed solution. The user may further review the expected costs/profits from the optimal solution to assess the desirability of conditions/requirements for the supply chain.

The user may review the aggregate, final results predicted for the optimal supply chain configuration. Alternatively, in one embodiment, the user may view the performance of an optimal supply chain configuration in each of multiple planning periods. This time-phased view allows the user to see trends in the supply chain that suggest necessary changes that may lead to more optimal configurations. For example, if a process in the suggested is initially profitable but quickly becomes losers of money, a more optimal configuration for the supply may stop the process after an initial planning period.

If no possible solution exists for optimization, the user may need to revisit the hard constraints to determine which one to relax (set to soft). Similarly, the user may extend the planning period so that the calculated lead-time of a process is not longer than overall planning calendar. Otherwise, the process will be ignored within the optimization.

The user may likewise choose to modify the optimization condition established in step 300, such as modifying the scenario or changing the goals for optimization. Then, after the user has modified the supply chain model or the optimization conditions, the user may then repeat the optimization of the supply chain in step 400.

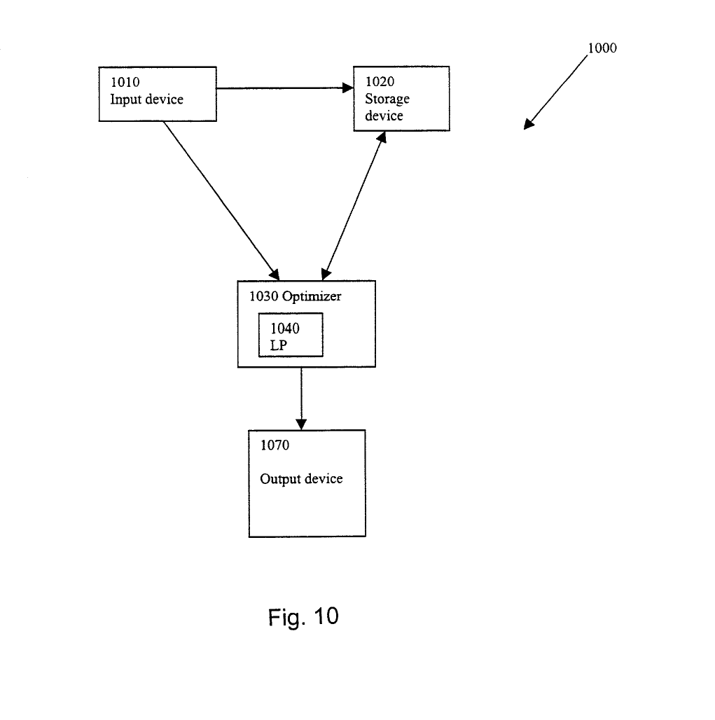

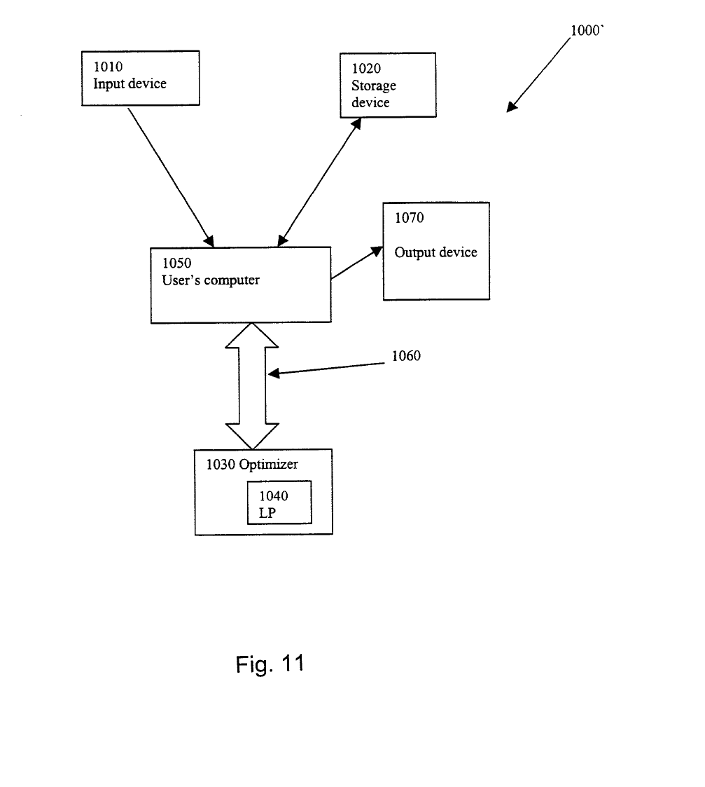

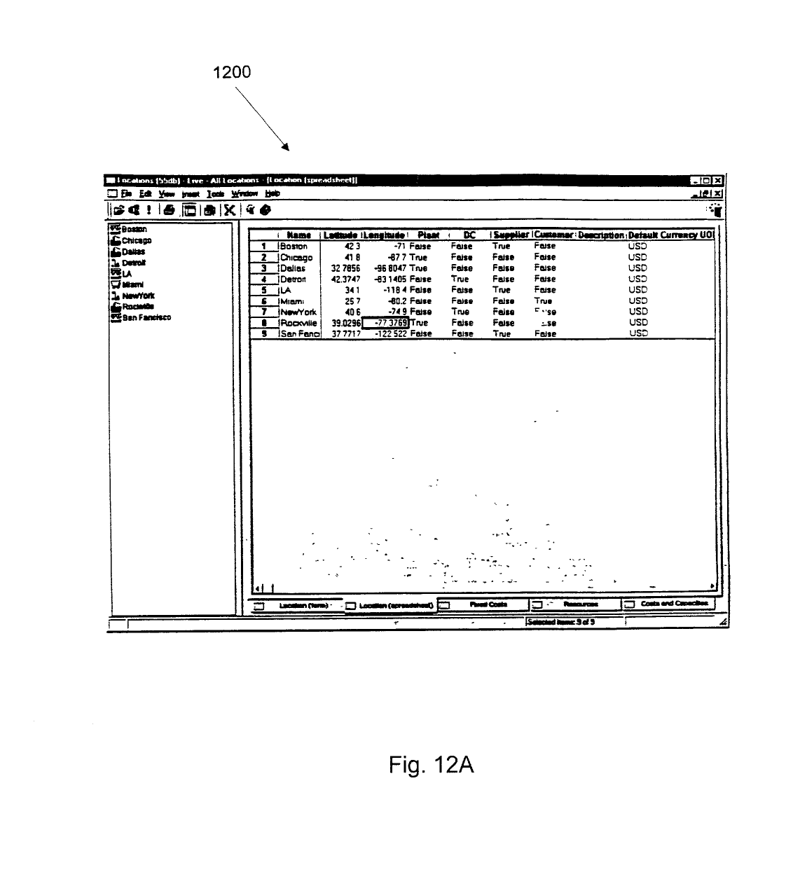

Turning to FIGS. 10 and 11, the optimization method 100 may be implemented using a supply chain optimization system 1000. As illustrated in FIGS. 10 and 11, the system 1000 includes an input device 1010. The input device is any type of known means through which the user may provide information in a digital format, as usable by a computing device. Typical input devices include keyboards and pointing devices, such as a mouse.

Returning to FIGS. 10 and 11, the system 1000 further includes a storage device 1020 for accepting and storing the user's input from the input device 1010. Similarly, the storage device may accept and store supply chain information from an outside source, as described above in step 201-205. More specifically, the present invention allows the user to model the user's supply chain with objects and processes, where these objects and processes are defined by their relationships to other objects or processes. To achieve this functionality, the storage device 1020 optimally stores the relationship between the locations, items, resources, and processes defined in step 200. Typically, the relationships are stored using some type of known relational database through which different data types (i.e., locations, items, resources, and processes) may be interconnected while minimizing storage space needs.

In storing the SKUs from step 240, the storage device 1020 optimally preserves referential integrity. Referential integrity refers to the use of consistent nomenclature for the same item at different locations. A SKU refers to an item at a specific location. If the item or the location does not exist, a SKU referring to a non-existent item or location has no meaning. If this condition is allowed to occur with data in a database, the database lacks integrity since the SKU refers to other pieces of data that do not exist. In other words, this database would lack referential integrity.

The present invention is designed to ensure referential integrity both proactively and reactively. In many situations, the present invention will proactively present choices to the user that ensure integrity is maintained. Creating a SKU is a good example. The user must select from a list of currently defined items and locations in order to create a SKU. There are situations, however, where the system is designed to react to changes that are attempted. For instance, attempting to delete a location that contains SKUs or make processes will cause the system to react by displaying a message rather than deleting the location without warning the user. If the user chooses to delete the location, the objects or processes that refer to the location will also be deleted.

The storage device would further store the optimization conditions defined in step 300. Specifically, the storage device could contain values/constraints for variables. The storage device may further contain Boolean variables specified by the user to direct the operation of the system 1000. Where the user defines a scenario, the storage device stores a copy of the original and modified supply chains, so that the user may compare and contrast solutions derived from both supply chains.

Returning to FIG. 10, the system 1000 further includes an optimizer 1030. The optimizer 1030 is a computational device that is electronically connected to the storage device 1020, such that the optimizer 1030 may access the information stored therein. Using this information, the 1030 may carry the supply chain optimization of step 400. Specifically, the optimizer carries out the linear programming to determine optimal solutions based on the supply chain problem as contained in the storage device 1020.

The optimizer 1030 may include a linear programmer 1040, or some other type of data analysis tool. These types of software are readily available or may be custom programmed using a known programming method, according to the needs of the optimization problems.

While the optimization is shown in proximity to the storage device 1020 and the input device 1010 in FIG. 10, FIG. 11 shows an alternative configuration for system 1000′ in which the storage device 1020 and the input device 1010 are electronically connected to a user computer 1050. In turn, the optimizer 1030 is connected to the user computer 1050 via an electronic communications line 1060. In this configuration, communication may run for a considerable difference. For example, the user computer 1050 and the optimizer 1030 may be connected through a closed network or an open network, such as the Internet.

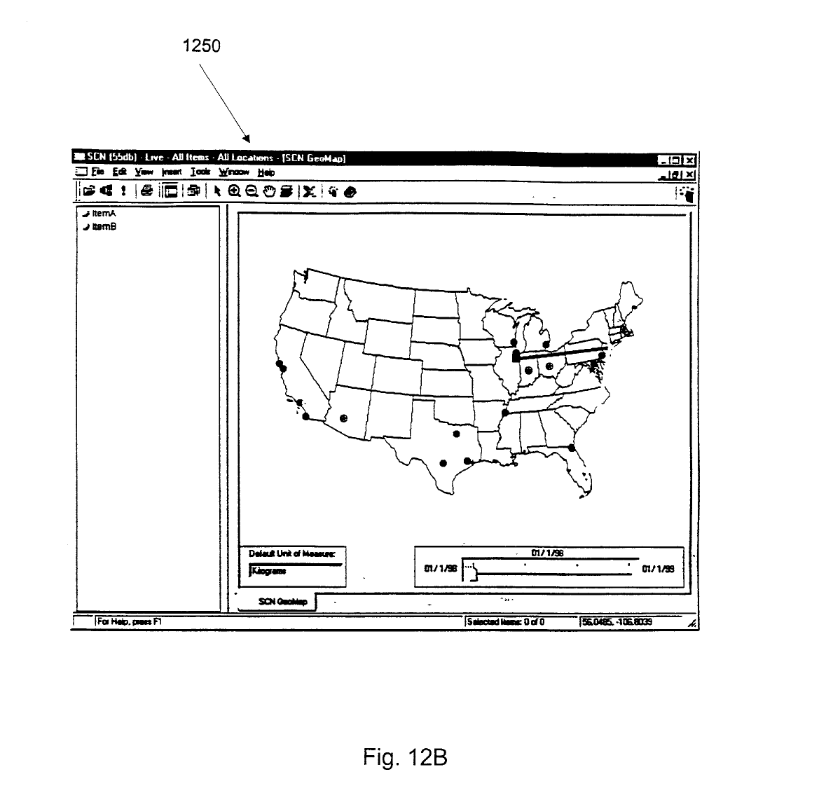

Both the configurations of the system 1000 and 1000′ further include an output device 1070 through which the user may receive the optimal supply chain configuration. The output device 1070 is any device that coverts digital information from the optimizer and converts this information into a comprehensible format. The output device 1070 is typically a video display or a printer. The output device 1070 may further present information on the supply chain model, as specified in step 200. For instance, the display device may graphically present the locations and lanes. FIGS. 12A-B display two exemplary outputs, showing representations of a supply chain. FIG. 12A illustrates a textual description 1200 of the location in a supply chain, while FIG. 12b illustrates a graphical display 1250 of the same locations.

After the supply chain is optimized in step 400, the results are displayed on the display device 1070 to the user in step 500. Specifically, the details on the optimal supply chain configurations are presented to the user along with details on this optimal solution, such as the expected cost/profits from this configuration. The user may further view more specific information such as the activities, costs, and profits from each location.

The display device 1070 may further display the fixed costs for the location, resources, and processes in the supply chain. While the optimizer 1030 does not consider fixed costs in determining optimal configurations for a supply chain, the user may wish to view this fixed cost to determine the viability of the supply chain. If the supply chain, even in an optimal configuration, cannot be profitable in view of the fixed costs, the user needs to consider changes to the supply chain.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed:

1. A method for producing an optimal configuration for a supply chain, the method comprising the steps of:
creating a supply chain model representative of the supply chain, said model defining one or more processes representing the activities within the supply chain;
defining optimization conditions for said supply chain model; and
determining an optimal configuration for the processes in said supply chain model in view of said optimization conditions.

2. The method of claim 1 further comprising the steps of: analyzing the optimal configuration for the supply chain;
reconfiguring the supply model as desired; and
re-optimizing the supply chain model.

3. The method of claim 1, wherein each of said processes is a make, move, purchase or sourcing process.

4. The method of claim 1, wherein the step of creating supply chain model comprises specifying one or more resources used or produced in each of the processes, wherein said processes are represented in equations representing the use or production of said resources.

5. The method of claim 4, wherein the step of determining an optimal configuration comprises performing linear programming using said equations.

6. The method of claim 4, wherein the step of determining an optimal configuration comprises performing mixed integer programming.

7. The method of claim 4, wherein the step of determining an optimal configuration comprising performing heuristics.

8. The method of claim 5, wherein the step of determining an optimal configuration comprising performing successive integer programming.

9. The method of claim 5, wherein the step of determining an optimal configuration comprising performing local searching heuristics.

10. The method of claim 4 further comprising the step of associating the resources to locations.

11. The method of claim 4 further comprising the step of defining a multi-tiered pricing for one of the resources.

12. The method of claim 4, wherein the multi-tiered pricing is directly determined.

13. The method of claim 4, wherein the multi-tiered pricing is cumulatively determined.

14. The method of claim 4 further comprising the step of specifying a constraint for said resources, said constraint limited the range of possible values for the resource in the optimal configuration.

15. The method of claim 14, wherein said constraint is hard, wherein said constraint cannot be broken in the optimal configuration.

16. The method of claim 14, wherein said constraint is soft, wherein said constraint can be broken in the optimal configuration at a penalty cost.

17. The method of claim 4 further comprising the step of specifying one or more units of measure for each of said resources.

18. The method of claim 4, further comprising defining the number of dimension for the resource.

19. The method of claim 1, further comprising the step of specifying a service level for one of the processes, whereby said service levels states minimum level of activity in the process at a location.

20. The method of claim 19 wherein said service levels specifies a minimum percentage of activity as measured by cost of one of the resources.

21. The method of claim 19 wherein said service levels specifies a minimum percentage of activity as measured by volume of one of the resources.

22. The method of claim 1 further comprising the step of specifying a maximum number of sources for one of the resources at a location in the supply chain.

23. The method of claim 1 further comprising the step of specifying a maximum number of sources for the resources at a location in the supply chain.

24. The method of claim 1 further comprising the step of specifying a lead time needed to initiate one of the processes.

25. The method of claim 1, further comprising the step of specifying the fixed costs for one of the processes.

26. The method of claim 1, wherein said step of creating a supply chain model comprises:
defining locations in the supply chain;
defining items in the supply chain; and
specifying which of said items appears at each of said locations.

27. The method of claim 26, wherein said step of creating a supply chain model further comprises the step of defining lanes between said locations.

28. The method of claim 27, wherein at least one lane is created between each location.

29. The method of claim 28 further comprising the step of specifying one of said lanes as a default lane between each location.

30. The method of claim 27, wherein a lane is created between several locations having an identical SKU.

31. The method of claim 27 further comprising the step of identifying one or more manufacturing plants, distribution centers, and storage facilities in the supply chain.

32. The method of claim 31 further comprising the step of identifying one or more customer locations in the supply chain.

33. The method of claim 26 further comprising the step of specifying pre-build time for one of the items, said pre-build time describing the amount of time needed to obtain the item for use in a process.

34. The method of claim 24, wherein each item at each location defines a SKU.

35. The method of claim 34 further comprising the step of specifying a supplier for the SKU.

36. The method of claim 34 further comprising the step of specifying a special delivery requirement for the SKU.

37. The method of claim 34 further comprising the step of specifying a target inventory for the SKU.

38. The method of claim 34 further comprising the step of preserving referential integrity for an item at several of the locations by using the SKU at these locations.

39. The method of claim 34 further comprising the step of designating the SKU as a raw good, a finished good, or a work-in-progress.

40. The method of claim 1, wherein information used to create the supply chain model is imported from an outside data source.

41. The method of claim 1, wherein information used to create the supply chain model is imported from a previously created supply chain model.

42. The method of claim 1, wherein information used to create a first portion of the supply chain model is copied and modified a second portion of the supply chain model.

43. The method of claim 1, wherein predefined data is used to create a portion of the supply chain model.

44. The method of claim 1, further comprising the step of itemizing tax and tariff information.

45. A system for optimizing a supply chain, the system comprising:
an input device for defining a supply chain model;
a storage device for storing said supply chain model; and
an optimizer for forming an optimal configuration for said supply chain model.

46. The system of claim 45 further comprising a display device for displaying said optimized supply chain model.

47. The system of claim 45, wherein supply chain model describes the processes in the supply chain.

48. The system of claim 47, wherein the supply chain model describes the resources, items, locations, and lanes in each of the processes.

49. The system of claim 45, wherein said optimizer comprises a linear programmer.

50. The system of claim 45, wherein said linear programmer performs heuristics when processes in the supply chain model are non-linear.

51. The system of claim 45 wherein said input device is connected to said optimizer through network connection.

52. The system of claim 51, wherein said network connection is the Internet.

53. A program storage device readable by a machine, tangibly embodying a program of instructions executable by a machine to perform method steps of optimizing a supply chain, the supply chain model having locations, items, and processes in the supply chain, the method steps comprising:
forming a supply chain model representing the locations, items, and processes in the supply chain;
defining optimization conditions for said supply chain model; and
determining an optimal configuration for the processes in said supply chain model in view of said optimization conditions.

54. The program storage device of claim 54 further comprising the method steps of:
analyzing the optimal configuration for the supply chain;
reconfiguring the supply model as desired; and
re-optimizing the supply chain model.
